(19) United States
(12) Patent Application Publication
(10) Pub. No.: US 2024/0051826 A1
(43) Pub. Date: Feb. 15, 2024

(54) REACTORS FOR FUEL REFORMING AND METHODS OF USE THEREOF

(71) Applicant: Georgia Tech Research Corporation, Atlanta, GA (US)

(72) Inventors: Andrei G. Fedorov, Atlanta, GA (US); David M. Anderson, Atlanta, GA (US)

(21) Appl. No.: 18/488,343

(22) Filed: Oct. 17, 2023

Related U.S. Application Data
(63) Continuation of application No. 17/196,404, filed on Mar. 9, 2021.
Application No. 17/196,404 is a division of application No. 14/669,583, filed on Mar. 26, 2015, now Pat. No. 10,988,379.
(60) Provisional application No. 61/971,066, filed on Mar. 27, 2014.

(51) Int. Cl. C01B 3/38

(52) U.S. Cl. CPC C01B 3/38; C01B 2203/0261; C01B 2203/041; C01B 2203/0425; C01B 2203/0475; C01B 2203/1235; C01B 2203/1041; C01B 2203/1058; C01B 2203/085; C01B 2203/1223; C01B 2203/1241; C01B 2203/0233

(57) ABSTRACT

The present disclosure provides compositions including method of producing H₂, variable volume reactors, methods of using variable volume reactors, and the like.

### CLAIM OF PRIORITY TO RELATED APPLICATION

This application is a continuation of co-pending U.S. Application entitled “REACTORS FOR FUEL REFORMING AND METHODS OF USE THEREOF”, having Ser. No. 17/196,404, filed on Mar. 9, 2021, which is a divisional application of U.S. Application entitled “REACTORS FOR FUEL REFORMING AND METHODS OF USE THEREOF”, having Ser. No. 14/669,583, filed on Mar. 26, 2015, now U.S. Pat. No. 10,988,379, Issued Apr. 27, 2021, which claims priority to U.S. provisional application entitled “SORPTION-ENHANCED CHAMP REACTORS FOR DISTRIBUTED FUEL PROCESSING AND POWER GENERATION WITH INTEGRATED CO₂ CAPTURE” having Ser. No. 61/971,066, filed on Mar. 27, 2014, all of which are entirely incorporated herein by reference.

### BACKGROUND

Natural gas has recently been touted as a bridge fuel to a low-carbon future because of its favorable hydrogen-to-carbon ratio and newly developed techniques to tap vast, previously inaccessible worldwide reserves. With its newfound abundance, additional methods of natural gas utilization are desirable, including approaches for efficient production of hydrogen in a small-scale, distributed fashion at the point of use. However, problems with technologies need to be overcome.

### SUMMARY

The present disclosure provides compositions including method of producing H₂, variable volume reactors, methods of using variable volume reactors, and the like.

An embodiment of the present disclosure includes a method of generating H₂ in a variable volume reactor, among others, that includes a cycle with the following steps executed in sequence: a) introducing a hydrocarbon fuel and a gas at a ratio into the variable volume reactor; b) causing the fuel and gas to react with assistance of a catalyst to produce H₂ and CO₂ products; c) increasing a rate of fuel conversion reaction by actively decreasing a volume of the variable volume reactor, wherein H₂ permeates through a selectively H₂ permeable membrane and is removed from the variable volume reactor, wherein CO₂ is adsorbed by a sorbent material; d) increasing the volume of the variable volume reactor causing the CO₂ to be desorbed from the sorbent material by decreasing the partial pressure of CO₂; and e) decreasing the volume of the variable volume reactor causing the CO₂ to be flowed out of the variable volume reactor through a valve.

An embodiment of the present disclosure includes a reactor structure, among others, that includes: an active piston that changes a volume of a variable volume reactor; and a structure that includes at least one of: a catalyst, a sorbent material, and a H₂ permeable membrane, wherein the sorbent material is present in the reactor structure, wherein the volume is the space between the active piston and the structure, wherein the variable volume reactor is configured so that products, CO₂ and H₂, are formed due to reaction of fuel, wherein the CO₂ is adsorbed by the sorbent material, and H₂ permeates through the H₂ permeable membrane to outside the variable volume reactor, and wherein the variable volume reactor is configured so that movement of the active piston sequentially first decreases the volume and increases H₂ partial pressure in the reactor volume, which causes an increase of the rate of reaction and hydrogen permeation through H₂ membrane and second increases the volume and decreases the partial pressure of CO₂ in the variable volume reactor, which causes the CO₂ to desorb from the sorbent material and be removed from the variable volume reactor using an open exhaust valve by movement of the active piston to decrease the volume and pushing the CO₂ out of the variable volume reactor.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1.1 is a flow chart illustrating an embodiment of the present disclosure.

FIG. 1.2 is an illustration of an embodiment of the present disclosure.

FIG. 1.3 is an illustration of another embodiment of the present disclosure.

FIG. 1.4 is an illustration of another embodiment of the present disclosure.

FIG. 1.5 is an illustration of another embodiment of the present disclosure.

FIG. 1.6 is an illustration of another embodiment of the present disclosure.

FIG. 1.7 is a digital image of a set-up of an embodiment of the present disclosure.

FIG. 2.1 illustrates the equilibrium CH₄ conversion fora reactor with (solid lines) and without (dashed lines) a selectively permeable H₂ membrane at various operating pressures (assumed uniform within the reactor).

FIG. 2.2 illustrates the CH₄ conversion enhancement by removal of CO₂ via adsorption both with (solid lines) and without (dashed lines) hydrogen separation via a membrane.

FIG. 2.3 illustrates a schematic of CHAMP-SORB reactor cycle. The reactor utilizes four strokes per cycle: (a) retracting piston to fill the reactor, (b) extending piston to produce H₂ via SMR at constant pressure and then opening valve to exhaust products, (c) retracting piston to desorb CO₂ and (d) extending piston to desorb and produce a purified CO₂ as the final product.

FIG. 2.4 is an illustration of impact of isotherm type on sorbent utilization and required reactor pressure and temperature. Type IV (top figure) isotherm allows a higher CO₂ pressure (P_{des}) during the desorption stage than the Type I (bottom figure) isotherm would require (P_{des}*). The same desorption pressure can be achieved with the Type I isotherm only by incorporating a temperature swing between reaction and desorption.

FIG. 2.5 illustrates the impact of S/C ratio on conversion, yield efficiency, thermal efficiency and hydrogen yield density of CHAMP-SORB reactor. Calculations made with a sorbent mass of 1 kg/(initial mol CH₄) at 400° C. without any fuel regeneration.

FIGS. 2.6A-C illustrate the CHAMP-SORB reactor cyclic performance without regeneration: (A) Regime map for thermal efficiency versus cyclic hydrogen yield density at varying S/C ratios ( [symbol] ) and sorbent mass (—); (B) Thermal efficiency and (C) Hydrogen yield density as a function of sorbent loading with S/C ratios chosen to maximize each metric.

FIGS. 2.7A and 2.7B illustrates the impact of recycle fraction on CHAMP-SORB reactor thermal efficiency and hydrogen yield density: (A) Regime map for 1 kg sorbent/mol CH₄; (B) Maximum thermal efficiency with optimal S/C ratio as a function of recycle fraction and corresponding yield density tradeoff.

FIG. 2.8 illustrates a regime map for CHAMP-SORB cyclic performance with exhaust recycling (all results are for different S/C ratios chosen to maximize thermal efficiency at each recycle fraction and sorbent mass combinations). Dashed lines represent foci of constant sorbent mass (per unit of added fuel) while solid lines represent foci of constant recycle fraction.

FIGS. 3.1A and 3.1B illustrate a graph of the maximum (equilibrium) CH₄ conversion achievable for a 2:1 S/C ratio batch of fuel for A) with H₂ removal only, and B) with H₂ and CO₂ removal (r=fraction of CO₂ removed from reactor).

FIG. 3.2 illustrates a CHAMP-SORB schematic and baseline operation sequence.

FIGS. 3.3A and B illustrate graphs of the impact of S/C ratio on CHAMP-SORB performance for A) 1 kg sorbent/mol CH₄ fuel, and B) for varying sorbent to fuel ratios.

FIG. 3.4 illustrates a schematic of the ideal CHAMP-SORB kinetics model schematic.

FIG. 3.5 illustrates a graph of the ideal kinetic model results with varying catalyst to mass fraction ϕ.

FIG. 3.6 illustrates a schematic of the piping and instrumentation diagram (P&ID) for experimental CHAMP-SORB testbed.

FIGS. 3.7A and 3.7B illustrate a graph of the CHAMP-SORB sub-process experiments for A) H₂ permeation and B) CO₂ adsorption.

FIG. 3.8 illustrates a graph of the CHAMP-SORB experimental results.

FIGS. 3.9A-C illustrate a graph of the comparison of experimental data to ideal kinetic model results for A) H₂ molar yield rate, B) reactor pressure and C) reactor height variation with time.

FIGS. 3.10A and 3.10B illustrate a graph of a comparison of CHAMP-SORB yield A) with and B) without a functioning CO₂ adsorbent.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method may be carried out in the order of events recited or in any other order that is logically possible.

Embodiments of the present disclosure will employ, unless otherwise indicated, techniques of engineering, chemistry, energy, physics, and the like, which are within the skill of the art. Such techniques are explained fully in the literature.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion:

The present disclosure provides compositions including methods of producing H₂, reactor structures, variable volume reactors, methods of using variable volume reactors, and the like.

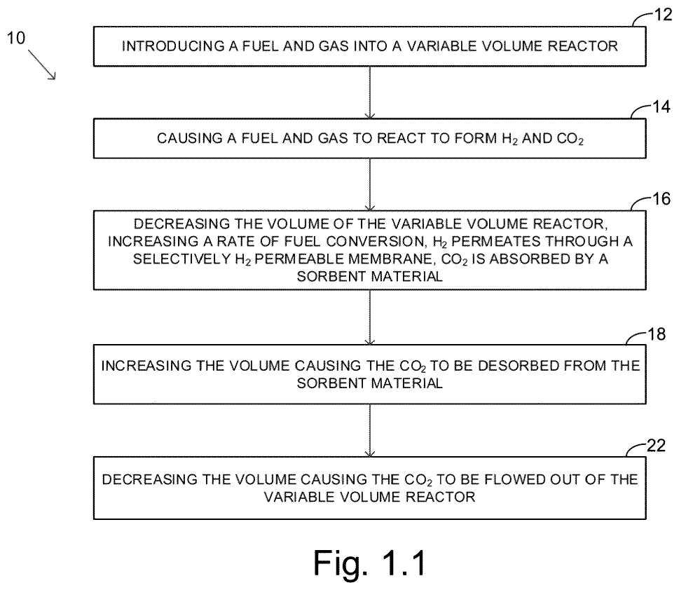

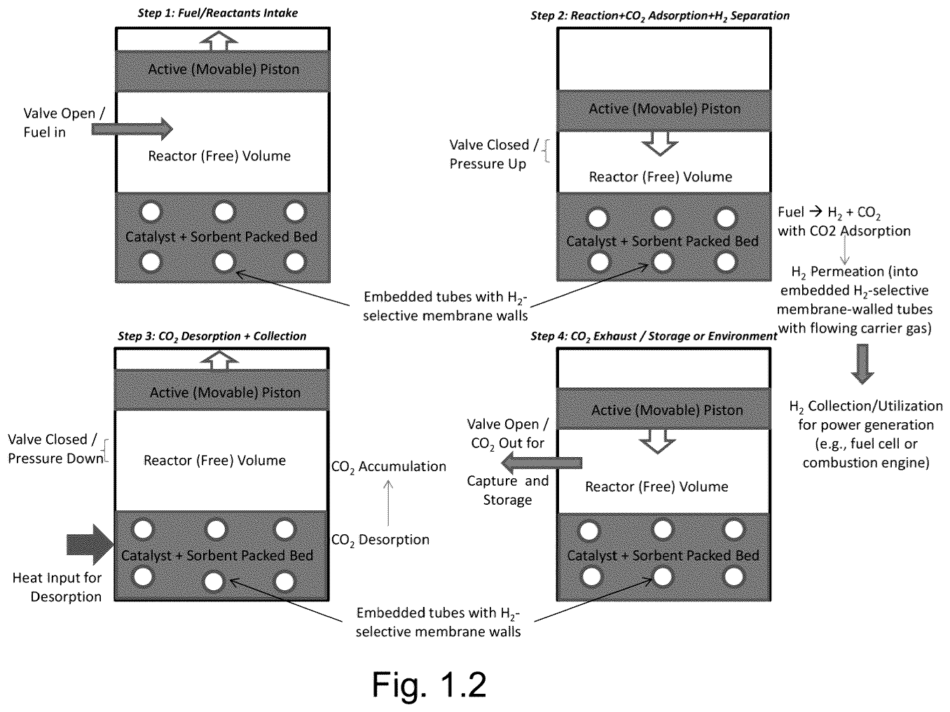

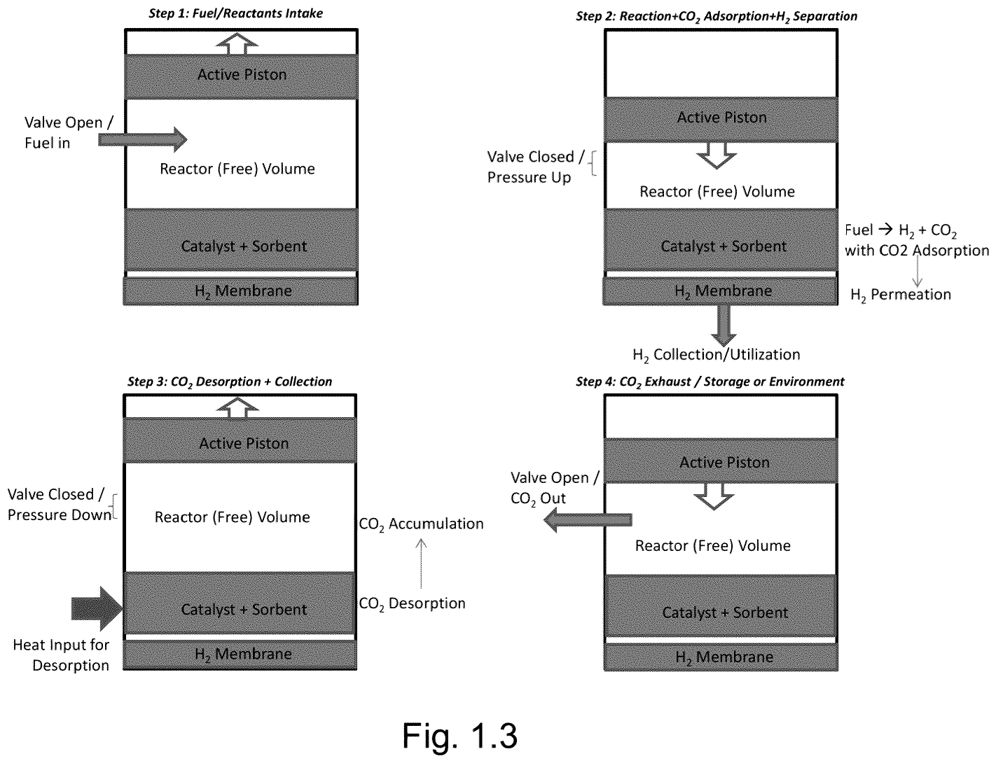

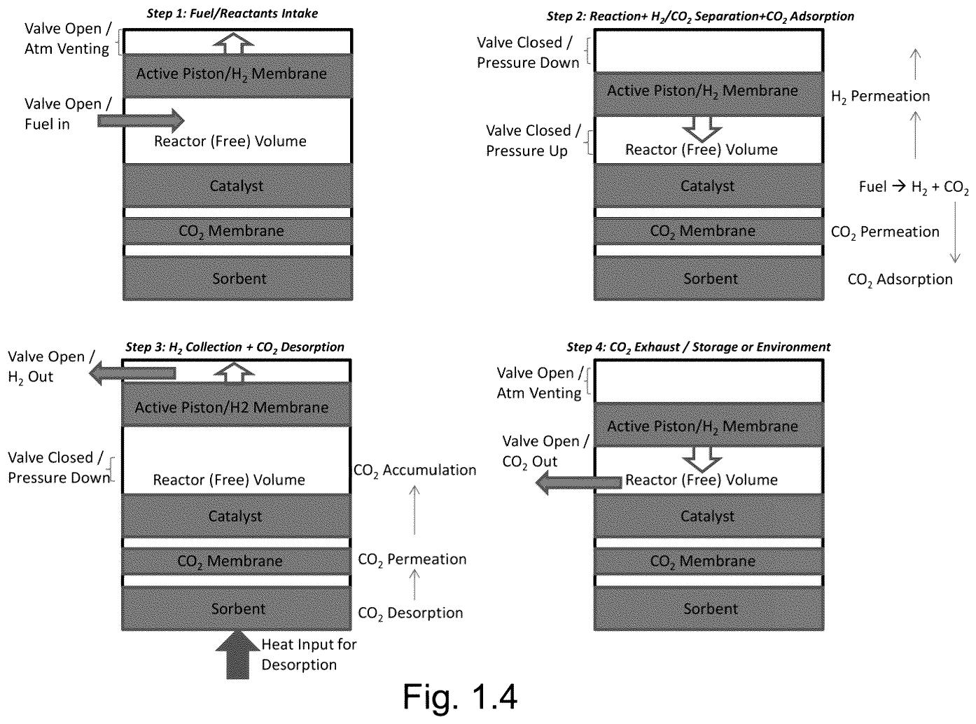

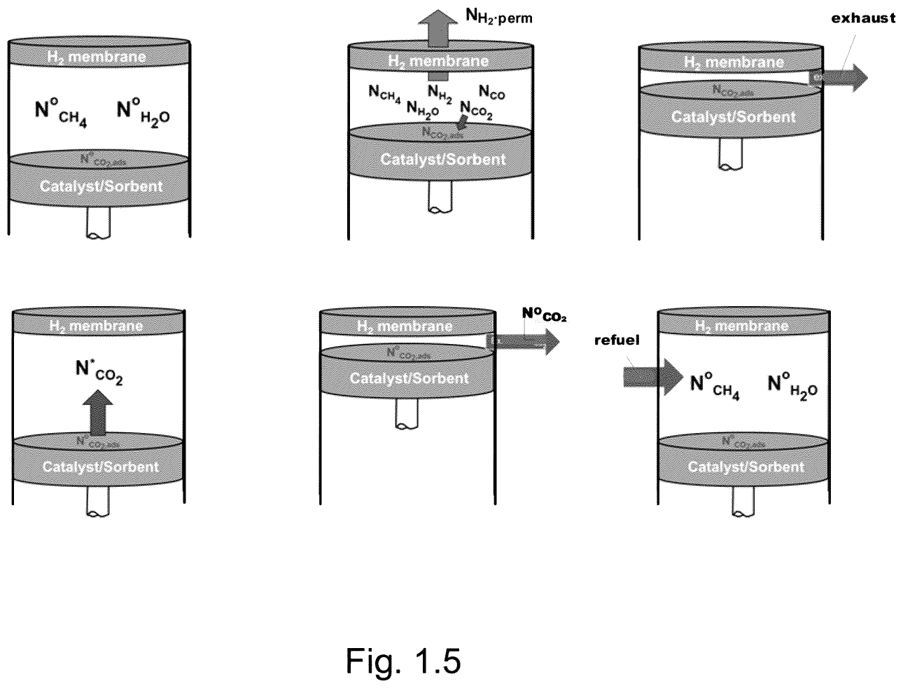

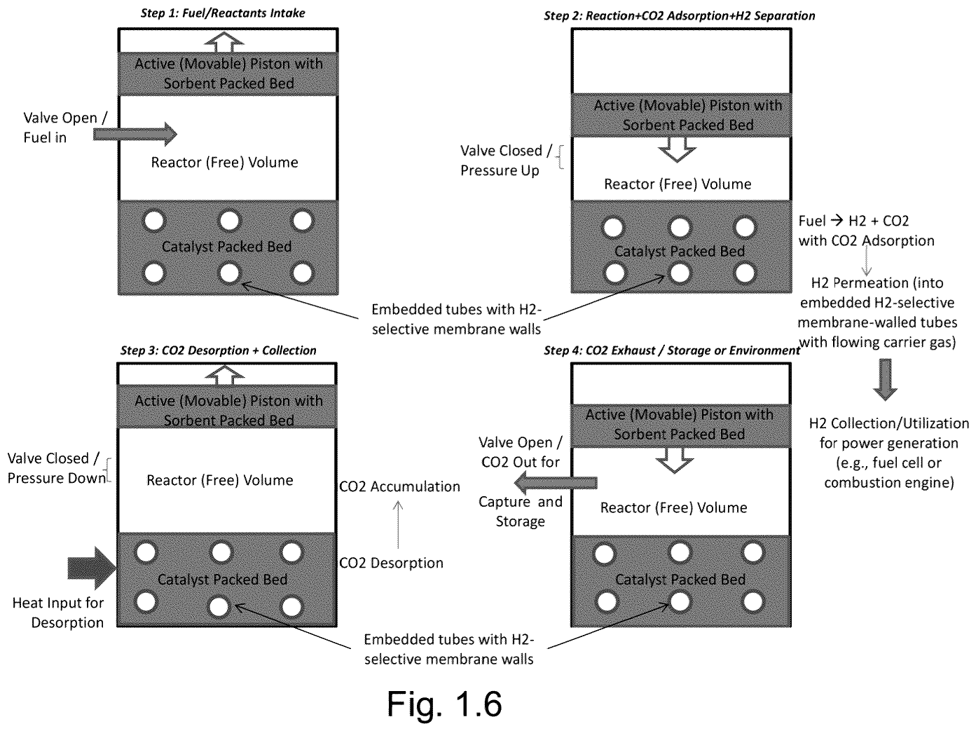

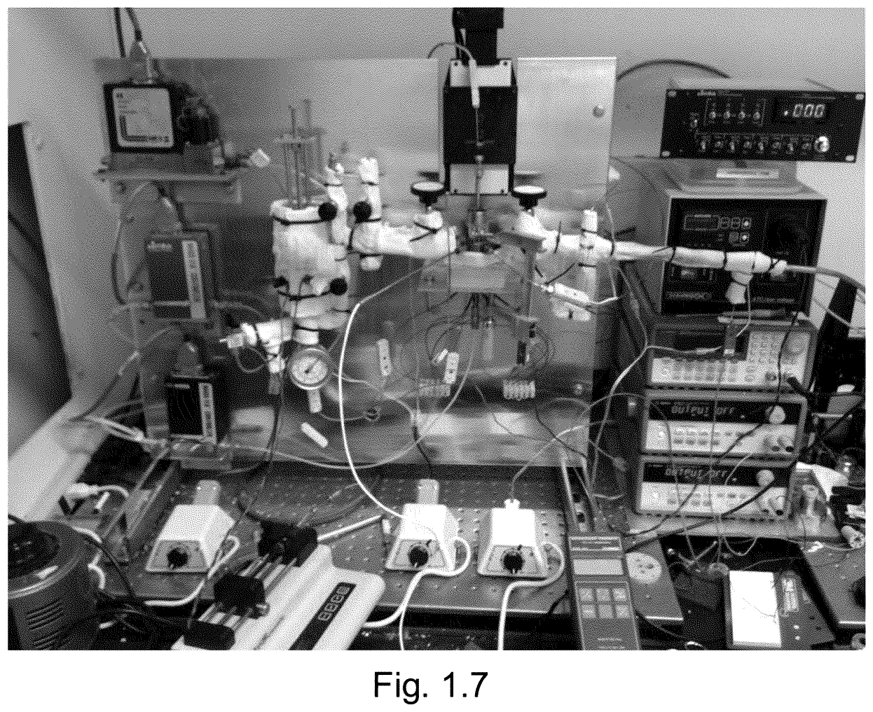

In general, an embodiment of the present disclosure includes a method for producing H₂ (10), or in the alternative another gas. As shown in FIG. 1.1, a fuel and gas are introduced into a variable volume reactor (12). The fuel and gas then react to form products (e.g., H₂ and CO₂) (14). The volume in the variable volume reactor can be decreased by movement of an active piston, which increases the rate of fuel conversion (16). H₂ permeates through the H₂ permeable membrane (e.g., selectively permeable to H₂ or other product gas of interest) and can be stored or used outside of the variable volume reactor, and CO₂ (e.g., or other product gas that needs to be adsorbed) is adsorbed by a sorbent material. Subsequently, the volume of the variable reactor can be increased (e.g., movement of the active piston) to cause the CO₂ to be desorbed from the sorbent material (18). The CO₂ can be caused to flow out of the variable volume reactor through a valve upon decreasing the volume of the variable volume reactor (e.g., by movement of the active piston) (22). Steps 18 and 22 can be repeated one or more times in sequence to allow for increased CO₂ removal without an increase in reactor size, which can achieve substantial or complete sorbent regeneration. Alternatively or in addition to, in step 18 the sorbent material can be heated to promote desorption of CO₂ by increasing the rate of desorption and to reduce the equilibrium amount of CO₂ that the sorbent material can hold. In an embodiment, after steps 16 and before 18, unreacted fuel, unpermeated residual products, and/or non-adsorbed residual products are flowed out of the variable volume reactor and into a second variable volume reactor and steps 14 to 22 are conducted in the (a) second variable reactor. Reactant and/or products can be removed using one or valves positioned to accomplish introducing and/or removing the reactant and/or product.

In an embodiment, the fuel can include: natural gas, methane, methanol, propane, butane, gasoline, diesel, a biofuel, or a combination thereof. In an embodiment, the gas can include a vapor such as steam or air, oxygen, or a combination thereof. In an embodiment, the variable volume reactor can be cooled or heated depending upon the reactants and if the reaction is exothermic or endothermic.

In general, an embodiment of the reactor structure includes an active piston that changes a volume of a variable volume reactor and a structure that includes at least one of: a catalyst, a sorbent material, and a H₂ permeable membrane (e.g., or alternative gas permeable membrane if other reactant gases are produced), where the volume is the space between the active piston and the structure. In an embodiment, the variable volume reactor includes the sorbent material (e.g., in the structure, active piston, and the like). In an embodiment, the variable volume reactor is configured so that products (e.g., CO₂ and H₂, or other products if other products are formed), are formed due to reaction of fuel. In an embodiment, CO₂ is adsorbed by the sorbent material (e.g., the sorbent material can be selected to adsorb other product gases) and H₂ permeates through the H₂ permeable membrane to outside the variable volume reactor. In an embodiment, the variable volume reactor is configured so that movement of the active piston sequentially first decreases the volume and increases H₂ partial pressure in the reactor volume, which causes an increase of the rate of reaction and H₂ permeation through H₂ membrane and second increases the volume and decreases the partial pressure of CO₂ in the variable volume reactor, which causes the CO₂ to desorb from the sorbent material and be removed from the variable volume reactor using an open exhaust valve by movement of the active piston to decrease the volume and pushing the CO₂ out of the variable volume reactor.

In an embodiment, the variable volume reactor (also referred to as CHAMP-SORP) incorporates CO₂ adsorption to complement the H₂ membrane separation, which allows a dramatic reduction in the operating temperature (e.g., improve energy efficiency) and enhance rate of fuel conversion/hydrogen production of the reforming process. An exemplary embodiment incorporates sorbent regeneration steps in its operating cycle, thereby preventing eventual saturation of the sorbent and enabling fuel (e.g., methane/natural gas) conversion enhancement for repeated cyclic operation. In particular, the active regeneration steps deviates from the traditional pressure swing adsorption (PSA) process of conventional flow reactors, as partial pressure of the adsorbed species is reduced by expanding the reactor volume as opposed to purging a fixed bed with an inert sweep gas. In this regard, the sorbent regeneration method, that does not require a sweep gas, can function by variable-volume batch operation of variable volume reactor and is desirable because it minimizes dilution of CO₂ during desorption, making it more energy efficient to capture. In an embodiment, the variable volume reactor can operate in a “closed-loop” mode with partial or full recycle of unreacted reaction products with recoverable energy content, which allows maximization of thermal efficiency and provides a compelling option for applications involving CO₂ capture combined with power (H₂) generation.

Embodiments of the present disclosure using variable volume (active piston) batch operation in conjunction with combined H₂ removal and CO₂ sorption allows one to achieve one or more of the following benefits: performing methane steam reforming reaction, which typically requires temperatures >800° C., at lower temperatures (e.g., about 150 to less than 800° C. or below 500° C.) to reduce material cost and preheating energy; reducing the overall system complexity and footprint due to use of multi-functional components integrated in the same reactor system; and operation at lower steam-to-carbon (S/C) ratio down to stoichiometric values for a given hydrocarbon fuel (e.g., 2 to 1 for methane as a fuel), which improves thermal efficiency, increases volumetric H₂ yield density, and minimize use of excess steam.

Embodiments of the present disclosure are advantageous because it is beneficial to bring the reforming catalyst/CO₂-sorbent/H₂-membrane in close proximity (i.e., have them co-located) to each other to minimize mass transfer limitations (i.e., improving species transport from the reaction site on the catalyst to product removal at the sorbent and membrane sites). In an embodiment, it may be advantageous to segregate domains (e.g., reforming catalyst/CO₂-sorbent/H₂-membrane) depending on heat transfer requirements and thermal stability/preferred range of operating temperatures. For example, the reforming catalyst and H₂ permeable membrane prefer high temperatures for improved reaction kinetics and greater H₂ permeation rate, whereas the CO₂ sorbent has greater adsorption capacity and better stability at lower temperature, so it may be beneficial to segregate the catalyst/H₂ permeable membrane and sorbent in different domains based on temperature distribution in the reactor, which can be established using different heating/cooling arrangements.

Now having described embodiments of the present disclosure in general, additional details will be described. In an embodiment, the method of generating H₂ in a variable volume reactor can include a cycle (where one or more steps can be repeated) with the following steps executed in sequence: a) introducing a hydrocarbon fuel and a gas (e.g., steam, air, oxygen, or a combination thereof) at a ratio (e.g., about 2:1 to 6:1 when using steam as co-reactant for fuel reforming) into the variable volume reactor (e.g., See FIGS. 1.2-1.6 for exemplary embodiments); b) causing the fuel and gas to react with assistance of a catalyst to produce H₂ and CO₂ products; c) increasing a rate of fuel conversion reaction by actively decreasing a volume of the variable volume reactor (e.g., movement of the active piston), wherein H₂ permeates through a selectively H₂ permeable membrane and is removed from the variable volume reactor, wherein CO₂ is adsorbed by a sorbent material; d) increasing the volume of the variable volume reactor (e.g., movement of the active piston) causing the CO₂ to be desorbed from the sorbent material by decreasing the partial pressure of CO₂; and e) decreasing the volume of the variable volume reactor (e.g., movement of the active piston) causing the CO₂ to be flowed out of the variable volume reactor through a valve. In an embodiment, step c′ can be added after step c and before step d, where unreacted fuel, unpermeated residual products, and/or non-adsorbed residual products can be flowed out of the variable volume reactor and into a second variable volume reactor and steps b-e can be conducted.

Additional details regarding embodiments of the method will be described in reference to various embodiments (See FIGS. 1.2-1.6). An embodiment of a structure including the variable volume reactor will be discussed followed by details regarding the method of generating H₂ in the variable volume reactor. This organizational approach is set forth for a number of embodiments. It should be noted that various features (e.g., sorbent material, catalyst, and the like, as well as various steps) will be introduced for one of the embodiments introduced first, and may not be repeated for sake of clarity, but the defined features are applicable for other embodiments consistent with the operation and structure of each embodiment. Embodiments of the variable volume reactor are described in FIGS. 1.2 to 1.6, and FIG. 1.7 illustrates a digital image of an embodiment of a reactor system that includes the variable volume reactor (each embodiment of the variable volume reactor could be included in such a reactor system). Additional details can be found in Examples 1 and 2.

In an embodiment as illustrated in FIG. 1.2, the reactor structure (or reactor system) can include an active piston that changes a volume of a variable volume reactor by moving. Movement of the active piston can be controlled by an external actuator, for example. The structure also includes a structure that includes a catalyst domain, a sorbent material domain, and a H₂ permeable membrane domain. The H₂ permeable membrane domain extends through the structure so H₂ permeates through the H₂ permeable membrane domain from inside the variable volume reactor to outside the variable volume reactor, where the H₂ can be stored for future use or used to produce energy. In an embodiment, the volume is the space between the active piston and the structure.

In an embodiment, the active piston can be made of metal, stainless steel, ceramics, and the like. In an embodiment, the container including the active piston, the structure, and the variable volume reactor can be made of metal, stainless steel, ceramics, and the like.

Both the active piston and the structure form an air-tight seal to contain the gas in the variable volume reactor. One or more valves can be used to introduce and/or remove gas from the variable volume reactor. Also, one or more valves can be used to introduce and/or remove gas (e.g. carrier gas such as argon or steam or permeated H₂) from the other side (not the variable volume reactor) of the active piston and from the other side (not the variable volume reactor) of the structure.

In an embodiment, the variable volume reactor is configured so that products, CO₂ and H₂, are formed due to reaction of fuel with the assistance of the catalyst. CO₂ is adsorbed by the sorbent material.

In an embodiment, the variable volume reactor is configured so movement of the active piston to decrease the volume and to increase the partial pressure of the H₂ in the variable reactor volume which causes the H₂ to transfer through the H₂ selectively permeable membrane to outside of reactor.

In an embodiment, the variable volume reactor is configured so that movement of the active piston increases the volume and decreases the partial pressure of CO₂ in the variable volume reactor, which causes the CO₂ to desorb from the sorbent material and be removed from the variable volume reactor using an opening connected via a valve (e.g., an open exhaust valve) by movement of the active piston to decrease the volume and pushing the CO₂ out of the variable volume reactor. As mentioned herein, the steps d and e can be repeated in sequence one or more times to increase the sorbent regeneration and/or the sorbent material domain can be heated to the rate and amount of CO₂ desorption.

In an embodiment, the H₂ permeable membrane domain is embedded into a H₂ permeable membrane structure that extends the thickness of the structure so that H₂ passes through the H₂ permeable membrane domain. In an embodiment, the structure can include one or more H₂ permeable membrane structures. For example, the H₂ permeable membrane structure can be a hollow structure such as a tube, where the H₂ permeable membrane domain is disposed within the H₂ permeable membrane structure. In an embodiment the length of the H₂ permeable membrane structure is based on the thickness of the structure (about 1 micrometer to 100 micrometers), and the H₂ permeable membrane structure should be long enough to extend the thickness of the structure so that H₂ can permeate through the H₂ permeable membrane structure. In an embodiment, the width or diameter of the H₂ permeable membrane structure can be about 1 mm to 10 mm. In an embodiment, H₂ permeable membrane structure can be exposed to steam on the side of the structure that is outside the variable volume reactor to enhance H₂ permeation through the H₂ permeable membrane domain.

In an embodiment, the catalyst domain, the sorbent material domain, and the H₂ permeable membrane domain are segregated. For example, each domain may be segregated so that the temperature of each domain can be controlled independently or allowed to adjust to the temperature of its surroundings.

In an embodiment, the H₂ permeable membrane domain (and in other embodiments the H₂ permeable membrane) can be made of a material such as microporous alumina (high permeability, poor selectivity), zeolites (moderate permeability and selectivity), perovskites (low permeability, high selectivity), and dense metallic membranes (relatively high permeability, and potentially infinite selectivity), metal alloys, and combinations thereof. The material selection and design of the membrane must be such that it is mechanically robust, provides sufficient permeability and selectivity, maximum active surface area for permeation, and minimal degradation of performance under reaction conditions. In an embodiment, palladium and palladium alloy membranes, often integrated as part of the porous structure for mechanical support, provide many of these characteristics (including nearly infinite selectivity to hydrogen).

In an embodiment, the sorbent material domain (in other embodiments the sorbent material) can be a high temperature sorbent. In addition to the isotherm shape considerations, the sorbent material domain has sufficient CO₂ adsorption capacity at temperatures above 400° C. and selectively adsorb CO₂ in presence of other gases, in particular water vapor. In an embodiment, the sorbent material can adsorb more than on type of product. In an embodiment, two or more types of sorbent materials can be used to adsorb one or more types of products. In an embodiment, the sorbent material domain can be a material such as: calcium oxide, lithium zircaonate, hydrotalcites, activated carbons, zeolites, organic-inorganic hybrids (e.g., amine functionalized silica), metal organic frameworks, and polymers (e.g., branch or hyperbranched polymers (e.g., an ethylene-amine hyperbranched polymer)), and a combination thereof. In an embodiment, the selection of the sorbent material can be based on one of the following: temperature range, kinetics and capacity. In an embodiment, the sorbent material domain can be K₂CO₃-promoted hydrotalcite (stable for up to 450° C.).

The catalyst domain (in other embodiments the catalyst) can include an oxidation catalyst, a reforming catalyst, a water-gas shift catalyst, a decomposition catalyst, a CO preferential oxidation (PROX) catalyst, and combinations thereof. In an embodiment, the catalyst domain can be a material such as: Ni, Co, Ru, Rh, Pd, or Pt, on MgAl₂O₄ and Al₂O₃—MgO supports, CuO—ZnO/Al₂O₃, Cu—ZrO₂/Al₂O₃, Cu—ZnO/Al₂O₃, Pt/Al₂O₃, CuO—ZnO—Al₂O₃—ZrO₂+ZSM⁻⁵; Pd—Cu on Al₂O₃ support, Ni on NiAl₂O₄ support, Ni—Al₂O₃ and Co/Al₂O₃, and Ni, Ru, or Rh on Al₂O₃ support. In an embodiment, the catalyst can be selected based on the specific hydrocarbon fuel being reformed—some examples include: methane—transitional and noble metals (Ni, Co, Ru, Rh, Pd, Pt, etc) on MgAl₂O₄ and Al₂O₃-MgO supports; methanol—CuO—ZnO/Al₂O₃, Cu—ZrO₂/Al₂O₃, and Cu—ZnO/Al₂O₃ and Pt/Al₂O₃; DME (dimethyl ether)—CuO—ZnO—Al₂O₃—ZrO₂+ZSM-5; propane/propene—Pd—Cu on Al₂O₃ support or Ni on NiAl₂O₄ support; gasoline—Ni—Al₂O₃ and Co/Al₂O₃; diesel and biofuels—Ni, Ru, or Rh on Al₂O₃ support. In particular, the oxidation catalyst can include, but is not limited to, Pt/Al₂O₃, Rh/Ce/Al₂O₃, and Cu/ZnO/Al₂O₃. The reforming catalyst can include, but is not limited to, Cu/ZnO/Al₂O₃, Pd/Zn/Al₂O₃, Ni/Al₂O₃, and the like. The water-gas shift catalyst reduces the amount of carbon monoxide in the products and produces additional hydrogen from unreacted carbon dioxide and steam. The water-gas shift catalyst can include, but is not limited to, Cu/ZnO/Al₂O₃, Fe—Cr/Al₂O₃, and the like. The decomposition catalyst can include, but is not limited to, Ni/SiO₂ Ni/Al₂O₃, and the like. The PROX catalyst can include, but is not limited to, Pt—Fe/Al₂O₃ and Pt—Rh/Al₂O₃.

In an embodiment, the weight ratio of catalyst domain to the sorbent material domain in the structure can be about 0.1:0.9 to 0.2:0.5.

It should be noted that variables such as reactor pressure, reactor temperature, the amount of catalyst used, the amount of CO₂ sorbent material used, and the like, depend upon the design of the reactor structure, the variable volume reactor, fuel, products, and the like. Having noted such variables, the amount of sorbent material can be chosen such that its CO₂ sorption capacity and kinetics of CO₂ sorption match the hydrogen removal rate (kinetics and total amount) by the membrane. In an embodiment, the reactor pressure can be about 1 bar to 20 bar, about 2 bar to 10 bar, or about 3 bar to 6 bar. In an embodiment, the reactor temperature can be about 200 to 1000° C., about 300 to 800° C., or about 400 to 600° C., but is generally lower than a system that flows gas to remove CO₂ from a sorbent bed. In an embodiment, the compression ratio (ratio of reactor volume at max and min upon piston movement) can be about 1 to 100, about 2 to 20, or about 3 to 5. In an embodiment, the ratio of the volume of catalyst domain to the total reactor volume can be about 0.01 to 1.0, about 0.05 to 0.6, or about 0.1 to 0.3. In an embodiment, the ratio of reactor volume to H₂ membrane surface area can be about 0.01 to 100 cm, about 0.1 to 10 cm, or about 0.5 to 1cm. In an embodiment, the ratio of catalyst domain mass to the sorbent material mass can be about 0.1 to 0.9, about 0.2 to 0.5, or about 0.3 to 0.4.

Now having described an embodiment of the variable volume reactor, additional details regarding the method of generating H₂ will be described. In an embodiment, step c) includes moving the active piston to reduce the volume (e.g., reduce by about 30 to 90%) to cause an increase in H₂ partial pressure and permeation through the H₂ permeable membrane domain out of the variable volume reactor.

In an embodiment, step d) can include moving the active piston to increase the volume to cause the CO₂ to be desorbed from the sorbent material by reducing the partial pressure of the CO₂. In an embodiment, the sorbent domain can be heated to cause the CO₂ to be desorbed from the sorbent material by reducing the equilibrium CO₂ sorption capacity of the sorbent material.

In an embodiment, step e) can include moving the active piston to decrease the volume to cause the CO₂ to be flowed out of the of the variable volume reactor through a valve (e.g., the open exhaust valve).

In an embodiment, during step b) the catalyst and H₂ permeable membrane domains are heated using by a gas (e.g., steam) from contact outside of the variable volume reactor to increase the rate of reaction and the rate of H₂ transfer from the catalyst domain through the H₂ permeable membrane domain.

Now referring to FIG. 1.3, in an embodiment, the reactor structure can include an active piston that changes a volume of a variable volume reactor, a structure that includes a catalyst and a sorbent material, and a H₂ permeable membrane. The H₂ permeable membrane is positioned adjacent the structure on the side opposite side the active piston so the structure is between the active piston and the H₂ permeable membrane. Although the structure and the H₂ permeable membrane are shown as separated in FIG. 1.3, an embodiment of the present disclosure has the structure and the H₂ permeable membrane disposed so that they touch each other and a space is not between them.

The catalyst material, the sorbent material, and the H₂ permeable membrane material can be those as described herein.

In an embodiment, the ratio of the catalyst to sorbent material in the structure can be about 0.2 to 0.5.

In an embodiment, the structure can have a thickness of a centimeter to 100 s of centimeters depending upon the size of the reactor structure. In an embodiment, the H₂ permeable membrane can have a thickness of about 10 micrometer to 50 micrometers.

The active piston, the structure, and the H₂ permeable membrane form an air-tight seal to contain the gas in the variable volume reactor. One or more valves can be used to introduce and/or remove gas from the variable volume reactor. Also, one or more valves can be used to introduce and/or remove gas (e.g. carrier gas such as argon or steam or permeated H₂) from the other side (not the variable volume reactor) of the active piston and from the other side (not the variable volume reactor) of the H₂ membrane.

In an embodiment, the variable volume reactor is configured so that products, CO₂ and H₂, are formed due to reaction of fuel with the assistance of the catalyst. CO₂ is adsorbed by the sorbent material.

In an embodiment, the variable volume reactor is configured so movement of the active piston decreases the volume and increases the partial pressure of the H₂ in the variable reactor volume which causes the H₂ to transfer (e.g., by permeation) through the structure and the H₂ selectively permeable membrane to outside of the variable volume reactor.

In an embodiment, the variable volume reactor is configured so that movement of the active piston increases the volume and decreases the partial pressure of CO₂ in the variable volume reactor, which causes the CO₂ to desorb from the sorbent material and be removed from the variable volume reactor using a valve (e.g., an open exhaust valve) by movement of the active piston to decrease the volume and pushing the CO₂ out of the variable volume reactor.

Now having described an embodiment of the variable volume reactor, additional details will be provided regarding the method of H₂ generation. Other features described herein are applicable to this method as long as they are consistent with this embodiment of the variable volume reactor and its operation, and such features are not repeated for sake of clarity.

In an embodiment, step c) includes moving the active piston to reduce the volume to cause the increase in H₂ partial pressure and increase rate of permeation through the structure and the H₂ permeable membrane out of the variable volume reactor.

In an embodiment, step d) includes moving the active piston to increase the volume to cause the CO₂ to be desorbed from the sorbent material by reducing the partial pressure of the CO₂. In an embodiment, the structure can be heated to cause the CO₂ to be desorbed from the sorbent material by reducing the equilibrium CO₂ sorption capacity of the sorbent material.

In an embodiment, step e) includes moving the active piston to decrease the volume to cause the CO₂ to be flowed out of the of the variable volume reactor through the open exhaust valve. As noted herein, steps d and e can be repeated sequentially multiple times and/or the sorbent material can be heated.

In an embodiment, during step b) the H₂ permeable membrane and the catalyst domain are heated from contact outside of the variable volume reactor to increase rate of reaction and to cause an increase of rate of H₂ transfer through the H₂ permeable membrane. In an embodiment, the heat can be generated from steam, for example flowing through tubes embedded into the catalyst domain where H₂ is being separated out.

Now additional details will be provided in regard to FIG. 1.4. In an embodiment, the reactor structure includes an active piston that changes a volume of a variable volume reactor, where the active piston includes a H₂ permeable membrane. In an embodiment, the active piston can be composed of material that is permeable to H₂, where the material is selected to achieve the desired H₂ transfer from inside to outside of the reactor volume as well as has the mechanical properties to operate as the active piston. In an embodiment, the active piston can include channels through the active piston that are made of H₂ permeable membrane. For example, one or more of the H₂ permeable membrane structure(s) described in reference to FIG. 1.2 could be used in the active piston. In another embodiment, the face of the piston oriented towards the variable volume reactor has a H₂ permeable membrane supported by a perforated plate to provide mechanical support for the thin membrane.

In addition, the reactor structure includes a catalyst structure that includes a catalyst, where the volume is the space between the active piston and the catalyst structure. The materials described herein regarding the catalyst can be used in the catalyst structure. In an embodiment, the catalyst structure can use a support (e.g., a mesh, a filter, perforated plate, etc.) to hold the catalyst material. The catalyst layer is designed so that reactants (e.g., fuel, steam) and products (H₂ and CO₂) can flow through the catalyst layer.

A CO₂ membrane can be disposed adjacent the catalyst structure that is on the side opposite the active piston. Also, a sorbent material layer can be disposed adjacent the CO₂ membrane on the side opposite the catalyst structure, where the CO₂ membrane is between the catalyst layer and the sorbent material layer. Although FIG. 1.4 illustrates a space between the catalyst layer and the CO₂ layer and between the CO₂ membrane and the sorbent layer, an embodiment of the present disclosure includes a design where there is no space between the catalyst layer and the CO₂ layer and between the CO₂ membrane and the sorbent layer.

The catalyst material, the sorbent material, and the H₂ permeable membrane material can be those as described herein.

In an embodiment, the catalyst structure can have a thickness of a centimeter to 10 s of centimeters or larger depending upon the dimensions of the reactor structure. In an embodiment, the CO₂ membrane can have a thickness of about 10 micrometers to 1 millimeter or larger depending upon the dimensions of the reactor structure. In an embodiment, the sorbent layer can have a thickness of a centimeter to 10 s of centimeters or larger depending upon the dimensions of the reactor structure.

The active piston, the catalyst layer, the CO₂ membrane, and the sorbent layer form an air-tight seal to contain the gas in the variable volume reactor. One or more valves can be used to introduce and/or remove gas from the variable volume reactor. Also, one or more valves can be used to introduce and/or remove gas (e.g. carrier gas such as argon or steam or permeated H₂) from the other side (outside of the variable volume reactor) of the active piston and from the other side (outside of the variable volume reactor) of the sorbent layer.

In an embodiment, the variable volume reactor is configured so that products, CO₂ and H₂, are formed due to reaction of fuel with the assistance of the catalyst. CO₂ is adsorbed by the sorbent material after its concentration is increased by selective passing through the CO₂ membrane.

In an embodiment, the variable volume reactor is configured so movement of the active piston decreases the volume and increases the partial pressure of the H₂ in the variable reactor volume which causes the H₂ to transfer through the H₂ permeable membrane to outside of variable volume reactor.

In an embodiment, the variable volume reactor is configured so that movement of the active piston increases the volume and decreases the partial pressure of CO₂ in the variable volume reactor, which causes the CO₂ to desorb from the sorbent material, pass through the CO₂ membrane, and be removed from the variable volume reactor using a valve (e.g., an open exhaust valve) by movement of the active piston to decrease the volume and pushing the CO₂ out of the variable volume reactor. As stated above, steps d and e can be repeated in sequence multiple times and/or the sorbent material can be heated.

Now having described an embodiment of the variable volume reactor, additional details will be provided regarding the method of H₂ generation. Other features described herein are application to this method as long as they are consistent with this embodiment of the variable volume reactor and its operation, and such features are not repeated for sake of clarity.

In an embodiment, step c) includes moving the active piston to reduce the volume to cause the increase in H₂ partial pressure and its permeation through the H₂ permeable membrane out of the variable volume reactor and to cause the increase in CO₂ partial pressure and its permeation through the CO₂ permeable membrane to pre-concentrate CO₂ in contact with the sorbent structure to increase equilibrium CO₂ sorption capacity by the sorbent material.

In an embodiment, step d) includes moving the active piston to increase the volume of the variable volume reactor to cause the CO₂ to be desorbed from the sorbent material by reducing the partial pressure of the CO₂.

In an embodiment, step d) includes heating the sorbent domain to cause the CO₂ to be desorbed from the sorbent material by reducing the equilibrium CO₂ sorption capacity of the sorbent material.

In an embodiment, step e) includes moving the active piston to decrease the volume of the variable volume reactor to cause the CO₂ to be flowed out of the of the variable volume reactor through the open exhaust valve.

In an embodiment, in step b) the H₂ permeable membrane is heated from contact outside of the variable volume reactor to cause H₂ transfer through the H₂ permeable membrane.

In an embodiment, during step b) the catalyst domain is heated from contact outside of the variable volume reactor to cause an increase of rate of reaction.

Now the embodiment corresponding to FIG. 1.5 will be described. In an embodiment, the reactor structure includes an active piston that changes a volume of a variable volume reactor, where the active piston includes a H₂ permeable membrane. The active piston in FIG. 1.5 is the same as the active piston in FIG. 1.4. The reactor structure can include a structure that includes a catalyst and a sorbent material. This structure is the same as the structure described in reference to FIG. 1.3.

The catalyst material, the sorbent material, and the H₂ permeable membrane material can be those as described herein.

In an embodiment, the catalyst structure can have a thickness of a centimeter to 10 s of centimeters or more depending upon the dimensions of the reactor structure. In an embodiment, the CO₂ membrane can have a thickness of millimeters to 10 s of millimeters or more depending upon the dimensions of the reactor structure. In an embodiment, the sorbent layer can have a thickness of centimeter to 10 s of centimeters or more depending upon the dimensions of the reactor structure.

The active piston, the catalyst layer, the CO₂ membrane, and the sorbent layer form an air-tight seal to contain the gas in the variable volume reactor. One or more valves can be used to introduce and/or remove gas from the variable volume reactor. Also, one or more valves can be used to introduce and/or remove gas (e.g. carrier gas such as argon or steam or permeated H₂) from the other side (not in variable volume reactor) of the active piston and from the other side (not in variable volume reactor) of the sorbent layer.

In an embodiment, the variable volume reactor is configured so that products, CO₂ and H₂, are formed due to reaction of fuel with the assistance of the catalyst. CO₂ is adsorbed by the sorbent material.

In an embodiment, the variable volume reactor is configured so movement of the active piston to decrease the volume and increase the partial pressure of the H₂ in the variable reactor volume, which causes the H₂ to transfer through the H₂ permeable membrane to outside of the variable volume reactor.

In an embodiment, the variable volume reactor is configured so that movement of the active piston increases the volume and decreases the partial pressure of CO₂ in the variable volume reactor, which causes the CO₂ to desorb from the sorbent material and be removed from the variable volume reactor using a valve (e.g., an open exhaust valve) by movement of the active piston to decrease the volume and pushing the CO₂ out of the variable volume reactor. As stated above, steps d and e can be repeated in sequence multiple times and/or the sorbent material can be heated.

Now having described an embodiment of the variable volume reactor, additional details will be provided regarding the method of H₂ generation. Other features described herein are applicable to this method as long as they are consistent with this embodiment of the variable volume reactor and its operation, and such features are not repeated for sake of clarity.

In an embodiment, step c) includes moving the active piston to reduce the volume to cause the increase in H₂ partial pressure and the rate of H₂ permeation through the H₂ permeable membrane out of the variable volume reactor.

In an embodiment, step d) includes moving the active piston to increase the volume of the variable volume reactor to cause the CO₂ to be desorbed from the sorbent material.

In an embodiment, step d) includes heating the sorbent domain to cause the CO₂ to be desorbed from the sorbent material by reducing the equilibrium CO₂ sorption capacity of the sorbent material.

In an embodiment, step e) includes moving the active piston to decrease the volume to cause the CO₂ to be flowed out of the of the variable volume reactor through the open exhaust valve.

In an embodiment, during step b) the H₂ permeable membrane and the catalyst are heated from contact outside of the variable volume reactor to increase the rate of reaction and to cause H₂ transfer through the H₂ permeable membrane.

Now the embodiment corresponding to FIG. 1.6 will be described. In an embodiment, the reactor structure includes an active piston that changes a volume of a variable volume reactor, where the active piston includes a sorbent material; and a structure that includes a catalyst domain and a H₂ permeable membrane domain. In an embodiment, the active piston can be composed of material that is sorbent material, where the material is selected to achieve the desired CO₂ adsorption as well as has the mechanical properties to operate as the active piston.

The structure includes a catalyst domain and a H₂ permeable membrane domain. The structure is similar to the structure in FIG. 1.2 except that the structure does not include the sorbent material domain. The H₂ permeable membrane domain extends through the structure so the H₂ permeates through the H₂ permeable membrane domain from inside the variable volume reactor to outside the variable volume reactor, where the H₂ can be stored for future use or used to produce energy. In an embodiment, the volume is the space between the active piston and the structure.

In an embodiment, the active piston can be made of metal, stainless steel, ceramics, and the like and covered by the sorbent material. In an embodiment, the active piston layer can be made of the sorbent material.

Both the active piston and the structure form an air-tight seal to contain the gas in the variable volume reactor. One or more valves can be used to introduce and/or remove gas from the variable volume reactor. Also, one or more valves can be used to introduce and/or remove gas (e.g. carrier gas such as argon or steam or permeated H₂) from the other side (not in the variable volume reactor) of the active piston and from the other side (not in the variable volume reactor) of the structure.

This embodiment is similar to the one described in FIG. 1.2, except the structure combines catalyst and H₂ permeable membrane domain and an active piston, which includes sorption material and separated from the catalyst and H₂ permeable membrane via variable volume reactor volume. Otherwise, the embodiments are very similar or the same. One advantage of this embodiment is that spatially separating the CO₂ sorbent domain from the catalyst domain and the H₂ permeable membrane domain mitigates the thermal effect, as the catalyst and H₂ permeable membrane benefit from heating during step b) of reaction/permeation, whereas CO₂ sorbent benefits from lower temperature during step b) as the equilibrium CO₂ sorption capacity increases with a decrease in temperature.

The catalyst material, the sorbent material, and the H₂ permeable membrane material can be those as described herein.

In an embodiment, the structure can have a thickness of a centimeter or 10 s of centimeters or more depending on the dimensions of the reactor structure.

The active piston and the structure form an air-tight seal to contain the gas in the variable volume reactor. One or more valves can be used to introduce and/or remove gas from the variable volume reactor. Also, one or more valves can be used to introduce and/or remove gas (e.g. carrier gas such as argon or steam or permeated H₂) from the other side (not the variable volume reactor) of the active piston and from the other side (outside of the variable volume reactor) of the sorbent layer.

In an embodiment, the variable volume reactor is configured so that products, CO₂ and H₂, are formed due to reaction of fuel with the assistance of the catalyst. CO₂ is adsorbed by the sorbent material.

In an embodiment, the variable volume reactor is configured so movement of the active piston decreases the volume and increases the partial pressure of the H₂ in the variable reactor volume, which causes the H₂ to transfer through the H₂ permeable membrane to outside of variable volume reactor.

In an embodiment, the variable volume reactor is configured so that movement of the active piston increases the volume and decreases the partial pressure of CO₂ in the variable volume reactor, which causes the CO₂ to desorb from the sorbent material and be removed from the variable volume reactor using a valve (e.g., an open exhaust valve) by movement of the active piston to decrease the volume thereby pushing the CO₂ out of the variable volume reactor. As stated above, steps d and e can be repeated in sequence and/or the sorbent material can be heated.

Now having described an embodiment of the variable volume reactor, additional details will be provided regarding the method of H₂ generation. Other features described herein are applicable to this method as long as they are consistent with this embodiment of the variable volume reactor and its operation, and such features are not repeated for sake of clarity.

In an embodiment, step c) includes moving the active piston to reduce the volume to cause the increase in H₂ partial pressure and permeation through the H₂ permeable membrane domain out of the variable volume reactor.

In an embodiment, step d) includes moving the active piston to increase the volume to cause the CO₂ to be desorbed from the sorbent material by reducing the partial pressure of the CO₂.

In an embodiment, step d) includes heating the sorbent domain to cause the CO₂ to be desorbed from the sorbent material by reducing the equilibrium CO₂ sorption capacity of the sorbent material.

In an embodiment, step e) includes moving the active piston to decrease the volume to cause the CO₂ to be flowed out of the of the variable volume reactor through the open exhaust valve.

In an embodiment, during step b) a structure including catalyst and H₂ permeable membrane domains is heated using steam from contact outside of the variable volume reactor to increase the rate of reaction and the rate of H₂ transfer from the catalyst domain through the H₂ permeable membrane domain.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLE 1

Combined reaction-separation processes are a widely explored method to produce hydrogen from endothermic steam reforming of hydrocarbon feedstock at a reduced reaction temperature and with fewer unit operation steps, both of which are key requirements for energy efficient, distributed hydrogen production. This example introduces a new class of variable volume batch reactors for production of hydrogen from catalytic steam reforming of methane that operates in a cycle similar to that of an internal combustion engine. It incorporates a CO₂ adsorbent and a selectively permeable hydrogen membrane for in situ removal of the two major products of the reversible steam methane reforming reaction. Thermodynamic analysis is employed to define an envelope of ideal reactor performance and to explore the tradeoff between thermal efficiency and hydrogen yield density with respect to critical operating parameters, including sorbent mass, steam to methane ratio and fraction of product gas recycled. Particular attention is paid to contrasting the variable volume batch-membrane reactor approach to a conventional fixed-bed reaction-separation approach. The results indicates that the proposed reactor is a viable option for low temperature distributed production of hydrogen from methane, the primary component of natural gas feedstock, including the possibility for low-energy-input CO₂ capture.

### Introduction

Natural gas has recently been touted as a bridge fuel to a low-carbon future because of its favorable hydrogen-to-carbon ratio and newly developed techniques to tap vast, previously inaccessible worldwide reserves [1, 2]. With its newfound abundance, additional methods of natural gas utilization are desirable, including approaches for efficient production of hydrogen in a small-scale, distributed fashion at the point of use. Distributed hydrogen production helps overcome one of the primary barriers to the implementation of a so-called “hydrogen economy”: the lack of a large-scale hydrogen delivery infrastructure[3]. [4-8] Owing to these distribution challenges, presently 95% of worldwide hydrogen production is captive (i.e., co-located production and usage) [9]. Implementation of efficient small-scale hydrogen production facilities from methane, the primary component of natural gas, at the point of use would allow extension of the captive production strategy to industrial/residential co-generation [10, 11] and on-vehicle [12] applications. To understand the challenges associated with this strategy, it is instructive to first briefly discuss the established large-scale industrial processes and consider the difficulties of scaling-down a similar approach for distributed hydrogen production.

Steam methane reforming (SMR) is an industrially mature technology that is the primary route of hydrogen production worldwide from natural gas, accounting for 95% of the hydrogen produced in the United States [13, 14]. The SMR process consists of the strongly endothermic reverse methanation reaction, Eq. (1, Example 1), and moderately exothermic water gas shift (WGS) reaction, Eq. (2, Example 1):

CH₄+H₂O [symbol] 3H₂+CO, ΔH_{298K}=206.1 kJ/mol (1)

CO+H₂O [symbol] H₂+CO₂, ΔH_{298K}=−41.2 kJ/mol (2)

The combined reaction is endothermic and stoichiometrically defines the maximum H₂ yield for a given quantity of CH₄:

CH₄+2H₂O [symbol] 4H₂+CO₂, ΔH_{298K}=164.9 kJ/mol (3)

Reactions (1-3, Example 1) occur in parallel, typically over a nickel catalyst [15]. Because reverse methanation is endothermic while the WGS reaction is exothermic and both reactions are equilibrium limited for typical reactor conditions, it is impossible to achieve complete conversion of CH₄ into CO₂ and H₂ in a single stage of a conventional continuous flow reactor [16]. To shift the equilibrium of the strongly endothermic reverse methanation reaction in a favorable direction of greater hydrogen yield, large-scale industrial steam reformers utilize an initial reactor stage that operates at a highly elevated temperature in a range of 800-900° C. The reformer is also fed with excess of steam (H₂O), i.e., a high steam to carbon (S/C) molar ratio, to promote further CH₄ conversion and to minimize catalyst coking. While the stoichiometry of the combined reaction, given by Eq. (3, Example 1), requires a S/C ratio of only 2, industrial SMR processes typically operate at a S/C ratio of between 3 and 6.

Because of the high operating temperature of the initial SMR reactor stage, which is thermodynamically unfavorable for conversion of CO to CO₂ via the exothermic WGS reaction, the effluent gas from a single stage reactor typically contains an unacceptably large 8-10% CO on a dry basis [13, 14]. To substantially reduce the CO concentration and to produce additional H₂, one or two subsequent low-temperature reactors are utilized with conditions favorable for the exothermic WGS reaction. For applications where extremely pure hydrogen is required, such as PEM fuel cells where CO concentrations above 20 ppm can poison the Pt catalyst [17], additional product purification is achieved via pressure swing adsorption (PSA) of residual carbon monoxide from the effluent of the low temperature WGS reactor. With numerous sequential unit operations, including intermediate heat exchangers for thermal management of the reagent/product streams between active (reaction/separation) units, as well as a need for high temperature operating conditions, it is clear that industrial SMR is capital intensive, technologically complex and challenging, and requires a large footprint; yet, it is currently the most cost-effective method of commercial scale hydrogen production [3].

On-site, localized production of production of hydrogen from methane at lower (and dynamically variable) throughputs, which can be used in conjunction with the current natural gas distribution infrastructure, places stringent demand on the complexity/cost, energy (thermal) efficiency and footprint of fuel processing strategy. Straight-forward miniaturization of the conventional industrial approach is not practical for scale-down because of the excessive operating temperature (with associated cost and thermal efficiency penalty) and at best linear footprint reduction with production capacity for multi-unit equipment (with possible “non-scalable” component bottlenecks). Thus, to effectively implement SMR processes in smaller-scale distributed applications, the following requirements must be met:
Lower operating temperature to reduce material cost and preheating energy requirements;
Multifunctional components (e.g., combined reaction/separation step, elimination of dedicated low temperature WGS reactors) to reduce the overall system complexity and footprint;
Operation at lower S/C ratio to improve thermal efficiency, to increase volumetric H₂ yield density, and to avoid use of excess steam, which may not be as readily available as it would be in a large-scale industrial plant.

Combined reaction-separation processes are an attractive means to reduce the required SMR operating temperature and increase the practicality of on-site hydrogen generation [18, 19]. By Le Chatelier's principle, selective removal of H₂ and/or CO₂ from the reactor shifts equilibrium toward greater fuel conversion and H₂ yield, thereby circumventing the thermodynamic equilibrium limitations of the SMR process. This results in a suitable level of conversion that can be achieved at much lower temperature, and even potential removal of subsequent WGS and PSA purification steps. Moreover, the in situ removal of the reversible reactions' products enhances the forward reaction kinetics by increasing instantaneous concentrations of the reagents, which can further reduce the required reactor volume for a given H₂ yield, thus increasing the power density. Two SMR reaction-separation processes that have been extensively investigated are packed-bed catalytic H₂ membrane reactors [20-23] and CO₂ sorption-enhanced reactors [11, 24-31]. Reactors incorporating CO₂ sorption, termed SE-SMR, produce an improvement in CH₄ conversion at temperatures below 500° C.; however, high S/C ratios (and thus large quantities of readily available steam) are required to achieve suitably high conversion, which is undesirable for distributed applications. Relatively little attention has been paid to reactor systems that incorporate combined H₂ membrane separation and in situ CO₂ sorption, with the exception of the work of Harale, et al. [32, 33].

The CO₂/H₂ Active Membrane Piston (CHAMP) concept is a variable volume batch-membrane reactor recently proposed for hydrogen production via steam reforming of hydrocarbons [34, 35]. The CHAMP operates in a cycle similar to the Internal Combustion (IC) engine, aiming to dynamically maintain the optimal conditions (pressure, temperature, and residence time) for (1) transport of reactants to the catalyst, (2) reaction kinetics at the catalyst, and (3) selective permeation of H₂ through a membrane. In particular, to counteract the effects of fuel depletion and reduction in reactor pressure due to permeation, strategic compression of the CHAMP reactor volume is utilized to increase the concentration of the remaining fuel and hydrogen, thereby providing additional driving force for reaction and permeation. Initial studies of the CHAMP reactor, utilizing methanol as a potential on-vehicle feedstock, demonstrated advantageous performance as compared to a traditional packed-bed continuous flow reactor in terms of the CHAMP's ability to overcome heat and mass transport limitations as well as to match transient H₂ product yield with its demand without sacrificing conversion or yield efficiency [34, 35].

The example investigates the use of methane as a feedstock in a CHAMP reactor, and to include selective CO₂ sorption to complement the membrane H₂ separation as part of the multi-functional fuel processing strategy to further enhance reactor performance. The remaining of this example explores the H₂ and CO₂ separation requirements to achieve desired conversion of CH₄ at low temperature. One of most important findings is that conversion above 90% at a temperature as low as 400° C. and low S/C ratios can only be achieved through a combination of both H₂ membrane separation and CO₂ removal by sorption. This is in contrast to the previous CHAMP studies involving methanol, where full conversion at low temperatures was possible with a hydrogen membrane alone because the methanol-steam reforming reaction is much less endothermic. In addition, this example describes how the CHAMP concept can be extended to include CO₂ sorption into a new reactor design termed CHAMP-SORB. Also the desired sorbent characteristics and their impact on the CHAMP-SORB reactor performance are discussed. Lastly, a thermodynamic framework for calculating the thermal efficiency of the entire CHAMP-SORB cycle. This section also reports the results of the energy efficiency analysis as function of the key process variables (pressure, temperature, S/C ratio, and sorbent mass), including the possibility of regenerative fuel processing to further increase the fuel conversion. The results are summarized in terms of regime maps for CHAMP-SORB operation, which can be effectively used as design tools for the matching the capabilities of the CHAMP-SORB cycle to the desired application requirements.

CO_{2/}H₂ Separation Requirements for Low Temperature SMR

Before considering a specific design of CHAMP class reactor that can achieve low temperature SMR with in situ separation of reaction products, it is useful to first investigate the degree of separation required to achieve high CH₄ conversion at low temperature in a general sense (i.e., without consideration of reactor type). During a combined reaction/permeation/adsorption process, the initial number of moles of each species j, Nⱼ⁰, evolves to a final value Nⱼ according to species conservation:

Nⱼ=Nⱼ⁰+(1−rⱼ)Σᵢεᵢvᵢⱼ−N_{j,perm} (4)

where rⱼ is the fraction of produced species j that is adsorbed from the gas phase of the reactor, εᵢ is the extent of reaction i, vᵢⱼ is the stoichiometric coefficient of the j^{th} component of reaction i, and N_{j,perm} is the number of moles of species j that permeates out from the reactor. The parameter rⱼ is non-zero for j=CO₂ only when considering CO₂ sorption, while the parameter N_{j,perm} is non-zero for j=H₂ only for the case of hydrogen removal through membrane separation.

If the reactions proceed to equilibrium, the reverse methanation, Eq. 5, Example 1, and water gas shift, Eq. 6, Example 1, reactions must satisfy the following constraints:

$${K}_{1} ( T ) = \frac{{y}_{{H}_{2}}^{3} {y}_{CO}}{{y}_{C {H}_{4}} {y}_{{H}_{2} O}} \cdot {[ \frac{{P}_{r x n}}{{P}_{r e f}} ]}^{2} \qquad ( 5 )$$

$${K}_{2} ( T ) = \frac{{y}_{{H}_{2}} {y}_{{CO}_{2}}}{{y}_{C O} {y}_{{H}_{2} O}} \qquad ( 6 )$$

where the equilibrium constants for reverse methanation (K₁) and WGS (K₂) are calculated as function of the reaction temperature using empirical correlations [36]. Lastly, if a selectively permeable H₂ membrane is present, the final H₂ partial pressure in the reactor must be equal to the hydrogen pressure on the permeate side of the membrane (P_{H}_{_{2,}}ₚₑᵣₘ) In the case of no membrane, this constraint reduces to a vanishing rate of H₂ permeation, i.e.,

P_{H}_{_{2,}}ₚₑᵣₘ=y_{H}_{₂}·P_{r×n} (with membrane)

or

N_{H}_{_{2,}}ₚₑᵣₘ=0 (without membrane) (7)

### Impact of Hydrogen Removal Via Membrane Separation on Equilibrium Conversion

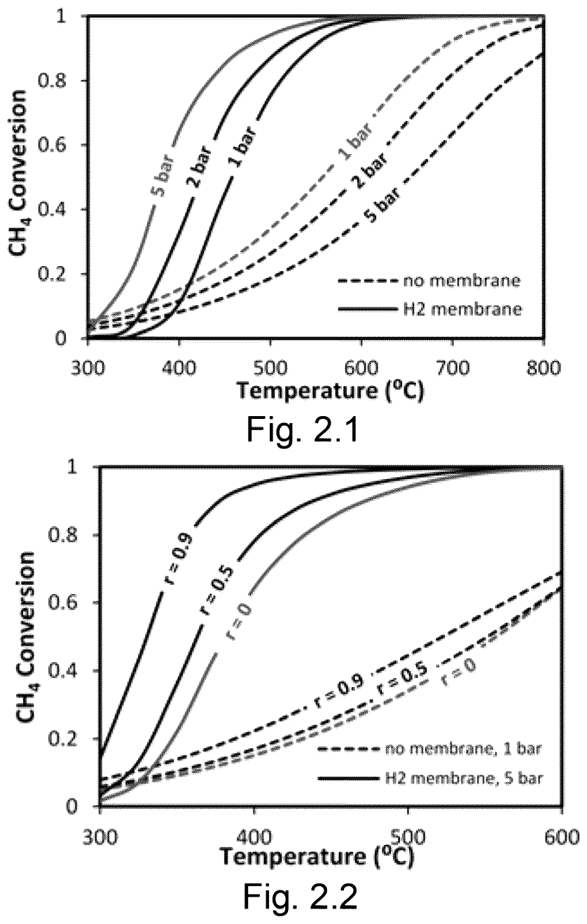

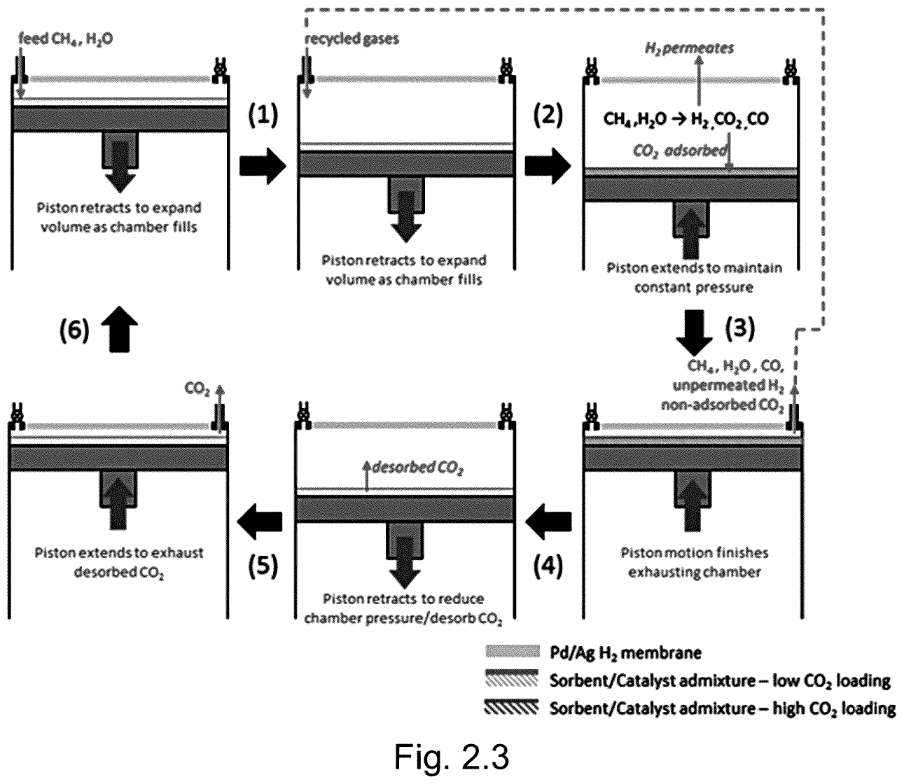

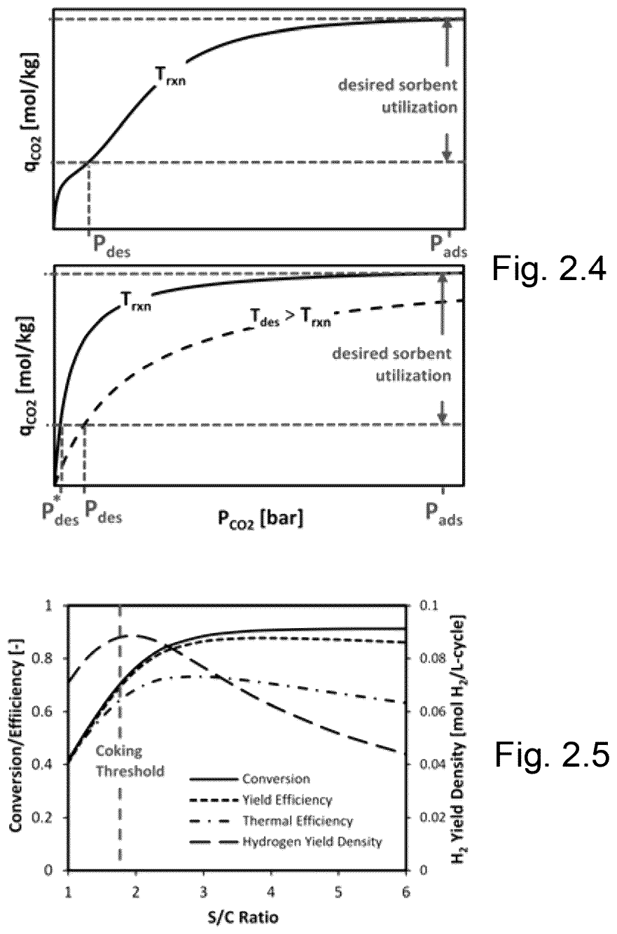

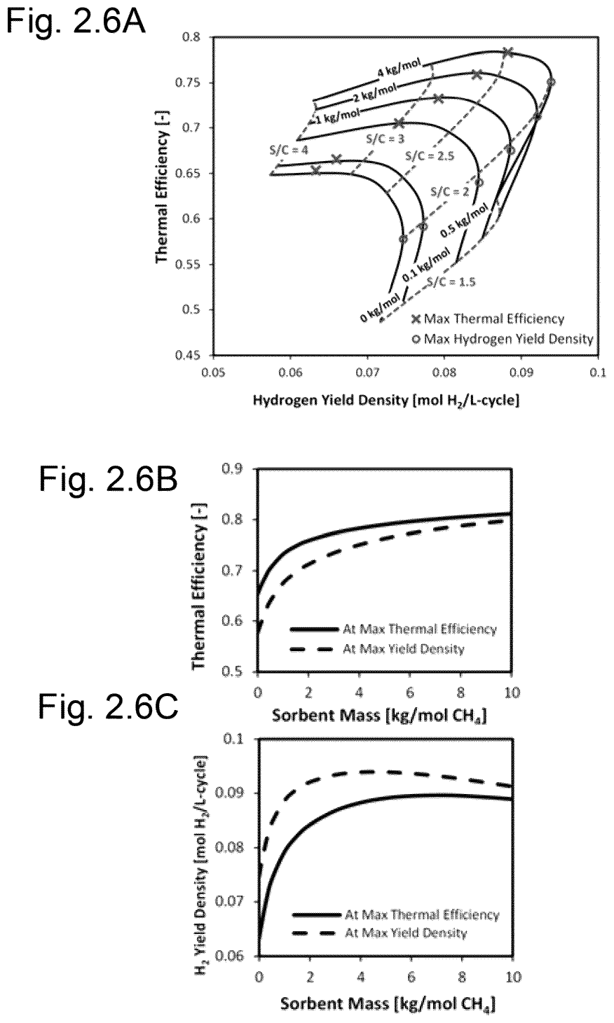

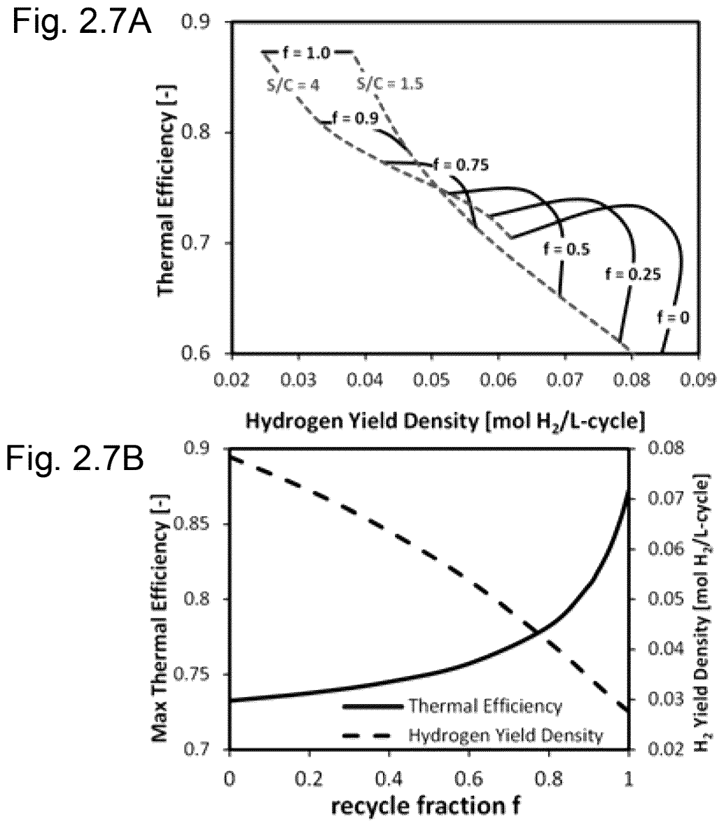

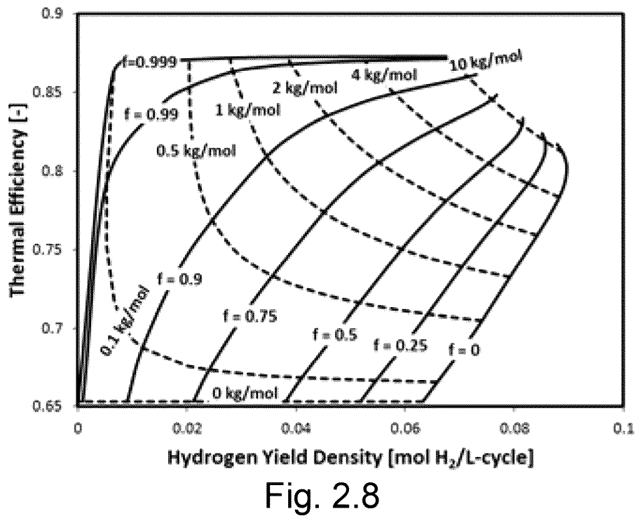

FIG. 2.1 shows the equilibrium CH₄ conversion at various pressures as a function of temperature of an initially pure methane-steam mixture with S/C ratio of 2. For cases with a membrane, the H₂ partial pressure on the permeate side of the membrane is held constant at 0.2 bar by an inert sweep gas or consumption in an appropriate (electro)chemical device. Without a membrane, reaction temperatures in excess of 700° C. are required to achieve a conversion of greater than 90%, while the same can be achieved at less than 500° C. with a membrane reactor at 5 bar reaction pressure.

It is important to note that without a membrane, conversion decreases with increasing pressure, as is expected from Le Chatelier's principle because an increasing number of moles result from the overall reaction. In contrast, with a membrane conversion increases with increasing pressure because of the additional removal of H₂ from the reaction chamber at higher pressures due to increased driving force for permeation across the membrane. This is important because it enables operation at higher pressure to increase the volumetric H₂ yield density without hurting the final achievable CH₄ conversion. Also when coupled with CO₂ adsorption operating at higher pressure with H₂ removal enables a higher CO₂ partial pressure and thus more favorable conditions for increased quantity of CO₂ adsorption. While increased reaction pressure is always favorable for equilibrium conversion with a membrane, the maximum pressure is limited by the mechanical strength of the membrane; this limit is arbitrarily set to be 5 bar.

At very low temperatures, the conversion without a membrane actually exceeds that of the membrane case. This is an artifact of setting the equilibrium hydrogen partial pressure on the retentate side to a fixed value equal to that of the permeate side. At low temperatures, so little hydrogen is produced by the chemical reactions that in order to satisfy Eq. (7, Example 1), hydrogen from the retentate side must actually permeate into the reactor (i.e., N_{H}_{₂}_{,perm}<0) to achieve equilibrium. The additional back-permeated hydrogen inhibits the equilibrium extent of the reactions and reduces the conversion as compared to the case without a membrane.

Equilibrium Conversion Enhancement with CO₂ Sorption

FIG. 2.2 illustrates the supplemental increase in CH₄ conversion which can be achieved by incorporating CO₂ adsorption. Calculations are made at 5 bar pressure for the case with a membrane and 1 bar without a membrane, because each represents the highest possible conversion without sorption within the pressure range considered. For each case, methane conversion with removal (r) of 50% and 90% of the produced CO₂ is plotted. With 90% CO₂ removal and H₂ separation via membrane, it is possible to achieve 90% CH₄ conversion at temperatures below 400° C. In contrast, without a membrane even removing a large fraction of the produced CO₂ does not result in conversions close to 90% in the temperature range considered (up to 600° C.).

Comparing the magnitude of conversion enhancement associated with CO₂ removal with and without a hydrogen permeable membrane, it is clear there is a synergistic effect in combining CO₂ sorption with H₂ removal. The use of a hydrogen membrane also appears to have a more significant impact on achievable conversion at a given temperature than CO₂ removal; this is to be expected because 3-to-4 molecules of H₂ are produced per molecule of CH₄ consumed while less than 1 molecule of CO₂ is produced (with the exact value of H₂ and CO₂ production depending on the extent of reverse methanation vs. WGS reaction). A key result of SMR thermodynamic equilibrium analysis is that both a hydrogen permeable membrane and CO₂ sorption are required for the CHAMP reactor to achieve a desirable conversion level (>90%) with methane as feedstock at temperatures as low as 400° C.

CHAMP Reactor with CO₂ Sorption

The equilibrium calculations for sorption requirements are general and made without consideration for how CO₂ is removed from the system or the type of reactor (batch or continuous flow). This section describes a particular embodiment of a modified CHAMP reactor, termed CHAMP-SORB, which can facilitate low temperature hydrogen production via SMR with selective CO₂ adsorption incorporated. It also discusses how the sorption isotherm's shape will impact the reactor performance and identifies the most appropriate sorbent option that matches with batch-mode operation of the CHAMP-SORB reactor.

### CHAMP-SORB Reactor Process Description

FIG. 2.3 illustrates the steps of the proposed cyclic CHAMP-SORB reactor with CO₂ adsorption. In contrast to the basic CHAMP embodiment [34], which utilizes only one intake and one reaction/exhaust stroke, the CHAMP-SORB reactor operates in a four-stroke cycle. Proceeding clockwise from top left in FIG. 2.3a the reactor is first filled with a mixture of CH₄ and H₂O, as well as recycled products from the previous cycle (if desired). The mixture then undergoes the steam-methane reforming reaction, which is enhanced by permeation of H₂ through the membrane and adsorption of CO₂. During this step, the piston moves upwards to maintain constant pressure as selected species are removed from the gas phase via adsorption and permeation, and the temperature is maintained by heating the sorbent/catalyst admixture layer (not shown). After the SMR reaction has proceeded sufficiently, the exhaust valve opens and the upstroke is completed to fully exhaust the chamber. As denoted by the dotted line, part or all of the exhaust gases can be recycled to the filling downstroke of the next CHAMP cycle if losses of residual hydrogen and unconverted methane upon exhaust are to be minimized. This recycling has a positive impact on thermal efficiency of the reactor, but can come at a significant cost to volumetric H₂ yield density. Once the chamber is exhausted, a second downstroke expands the chamber volume to reduce pressure and to facilitate desorption of CO₂, with heat addition to maintain temperature during the endothermic desorption process. Lastly a second upstroke exhausts the desorbed CO₂ from the reaction chamber, allowing it to be captured if desired. Note that CO₂ may not be fully removed during the desorption step and this sorbent loading will then be carried over to the start of the subsequent cycle.[37]

To model the cyclic performance of the CHAMP-SORB reactor, species conservation is solved at each of the states 1-6 labeled in FIG. 2.3a. It is assumed that the reaction/permeation/adsorption and desorption steps both proceed fully to equilibrium and that sufficient heat is added to maintain isothermal conditions. It is also assumed that the filling processes 6-1-2 is fast enough that no CO₂ adsorption/desorption or SMR reaction occurs during this step. Similarly no change in sorbent loading is assumed to occur in the CO₂ exhaust step 5-6. Lastly, the system is modeled as if the chamber can be completely exhausted (i.e., neglecting any dead volume) at states 4 and 6 when the piston is fully extended and the top of the sorbent/catalyst admixture layer reaches the membrane; this assumption is valid with a thin layer of sorbent but as the sorbent volume increases the amount of gas contained within the sorbent void fraction may become significant.

In addition to solving the species balance, it is necessary to determine the required heat and work inputs for each step of the process to enable calculation of the overall thermal efficiency as a function of key process variables (temperature, pressure, S/C ratio, sorbent mass and recycle fraction). In doing so it is assumed that all expansion or compression steps are frictionless, quasi-equilibrium processes. The volume expansion during desorption step is assumed to occur slowly enough that the CO₂ loading of the sorbent remains in equilibrium with the surrounding gas. Supplementary document S1 details the full set of equations and solution procedure for the species balance at each state 1-6, along with the required heat and boundary work inputs for each process.

### Impact of Sorption Isotherm Shape on CHAMP-SORB Performance

Because the sorbent loading from a previous cycle is carried over to the next, the amount of CO₂ removed by adsorption during the reaction process 2-3 is equivalent to the amount desorbed during the volume expansion process 4-5. This removed quantity of CO₂, N_{CO}_{₂}_{,des}, is equal to the mass of sorbent, m_{sorb}, multiplied by the difference in mass-based sorbent loading, q_{CO}_{₂}, between state 3 (with high loading at “low” reaction temperature T₃=T_{r×n} and “high” adsorption pressure P₃=P_{ads}) and state 5 (with low loading at “high” desorption temperature T₅=T_{des} and “low” desorption pressure P₅=P_{des}).

N_{CO}_{₂}_{,des}=m_{sorb}[q_{CO}_{₂} (T_{r×n},P_{ads})−q_{CO}_{₂}(T_{des},P_{des})] (8)

The shape of the adsorption isotherm will then have significant impact on the achievable CO₂ removal and the effective sorbent utilization. To illustrate this impact, FIG. 2.2 shows two isotherms with identical saturation capacity at high CO₂ pressure and the same slope in the low-pressure Henry's region at a given temperature. The bottom isotherm is a classic Type I Langmuir isotherm while the top isotherm is Type IV by Brunauer classification [38], with two inflection points and a concave up region at moderate pressure which is often used to represent a multi-layer adsorption behavior. To achieve a desired sorbent utilization under isothermal conditions, the pressure in the chamber for the Langmuir isotherm must be brought lower (P_{des}*) than would be required for the sorbent with the Type IV isotherm (P_{des}). Alternatively, if the same desorption pressure (e.g., P_{des}) were desired for the Langmuir isotherm, combined temperature/pressure swing would have to be utilized (T_{des}>T_{r×n}) in order to achieve the same amount of CO₂ desorption.

Desorption pressure is critical for the cyclic CHAMP-SORB reactor, which relies on volume expansion alone to achieve the desired pressure swing. As such, the desorbed CO₂ remains in the reactor chamber, and the required expansion volume (state 5 in FIG. 2.3a) is related to the CO₂ desorption pressure by the ideal gas equation of state:

$${P}_{d e s} = \frac{{N}_{C {O}_{2} , des} R T}{{V}_{5}} \qquad ( 9 )$$

As the required desorption pressure to achieve a desired sorbent utilization goes to zero, the required desorption volume approaches infinity. For distributed applications where a small footprint is required, a realistic practical limit on the desorption volume is that it matches the maximum volume of the system when filled with fuel at state 2. Comparing the isotherms of FIG. 2.2, a sorbent with a Type IV isotherm is preferred for the batch reactors such CHAMP-SORB because it leads to a less stringent low pressure requirement for adequate desorption than would be required for a Type I isotherm sorbent.

Comparison Between CHAMP-SORB and Traditional SE-SMR with PSA Regeneration

Because the utility of a sorbent is lost when it becomes saturated, sorption-enhanced (SE) reaction processes are inherently transient whether a variable volume batch or fixed bed flow arrangement is used. The traditional approach to SE-SMR employs at least two fixed bed reactor units operating out of phase, with one regenerating while the other is producing hydrogen. When PSA is used for sorbent regeneration, CO₂ desorption is accomplished by reducing reactor pressure below that of the reaction/adsorption step, followed by flushing the chamber with a purge gas and then repressurizing with a portion of the H₂ product gas. During the purge and repressurization step, the flow is in the reverse direction to that of the reaction/adsorption step to push the CO₂ sorbent loading front towards the entrance of the reactor, ensuring that essentially pure H₂ product (on a dry basis) occupies the reactor volume at the end of desorption/regeneration phase, which is then pushed out the reactor when the flow direction is again switched and the subsequent reaction step begins [39]. For applications where CO₂ sequestration is desired, steam has been proposed as the most suitable purge gas because it can be easily condensed out from the mixture; however it has been shown that an extremely high ratio of purge gas to desorbed CO₂ (greater than 60:1) is required to fully regenerate the sorbent [26]. A similar approach using temperature swing adsorption (TSA) at constant pressure as opposed to PSA has been proposed, but it still requires a significant amount of purge steam in a ˜6:1 ratio with respect to H₂ product [11]. Accounting for the 1 to (3 or 4) ratio of CO₂ to H₂ produced by the overall SMR reaction, this equates to a roughly 20:1 ratio of purge gas to desorbed CO₂. As explained in the introduction section of this paper, this can be problematic for distributed and size-constrained applications where steam may be less readily available and its use would be detrimental from the reaction yield density prospective. Additionally, the energy required to generate steam in the ratios described above can dramatically lower the process energy efficiency.

The CHAMP-SORB offers additional benefits over the traditional SE-SMR process in that it does not require purge gas when desorbing the CO₂. Because the catalyst/sorbent admixture only fills a small portion of the reactor, it is possible to exhaust most of the gas by moving the piston to a position corresponding to minimum reactor volume. The purity of the H₂ product is ensured by membrane separation, so small amounts of residual CH₄, CO, and CO₂ carried over to a subsequent cycle are not an issue. The CHAMP-SORB does have a disadvantage, however, in that regeneration of the sorbent is limited by the presence of desorbed CO₂ in the reactor chamber. This limitation can be seen in the coupling of Eqs. (8, Example 1) and (Eq. 9, Example 1): as the volume is expanded, more CO₂ is desorbed according to the adsorption isotherm, which in turn limits the reduction in chamber pressure associated with the expansion process. Because the desorbed CO₂ remains in the chamber it is not possible to fully regenerate the sorbent in the CHAMP-SORB reactor when the reactor volume at the end of the expansion/desorption step, which is capped by the initial volume occupied by the feed gas during the intake step. This is in contrast to a traditional PSA process, where the desorbed CO₂ is continuously exhausted from the reactor with a non-adsorbing purge species, and it is possible to fully regenerate the sorbent with sufficient purge gas flow.

The regeneration behavior of the CHAMP-SORB reactor has an interesting impact on the level of mass-based sorbent utilization, defined as the difference in loading between the adsorption and desorption steps and illustrated in FIG. 2.2, as additional sorbent is incorporated in the reactor. If total reactor pressure is sufficiently high, the sorbent loading (per unit mass of sorbent) at the end of the reaction/adsorption step, q_{CO}_{₂}(T_{des}, P_{ads}) remains nearly constant, regardless of sorbent mass, because the CO₂ partial pressure is high enough to fully saturate the sorbent. When the piston is moved to the system's maximum volume state to induce desorption, as more sorbent is present more CO₂ will be released into the gas phase according to Eq. (8, Example 1). This in turn means that, as indicated by Eq. (9, Example 1), the CO₂ pressure at the end of the desorption step will be higher as more sorbent is added to the reactor. The CO₂ desorption pressure and sorbent loading at state 5, q_{CO}_{₂}(T_{des}, P_{des}), are linked by the adsorption isotherm, with loading monotonically increasing with pressure regardless of whether the isotherm is Type I or IV. As such, higher CO₂ desorption pressure corresponds to higher sorbent loading at the end of the desorption step (less complete desorption per unit mass) and thus lower specific sorbent utilization. There is therefore a diminishing returns associated with increasing the sorbent mass, in that adding more sorbent results in a lower effective working capacity.

### Selection of CO₂ Sorbent

Having discussed the general impact of the sorption isotherm on the CHAMP-SORB performance, specific high temperature sorbents are now considered to determine the most appropriate option for this application based on the currently available materials as reported in the literature. In addition to the isotherm shape considerations, the sorbent must have sufficient CO₂ adsorption capacity at temperatures above 400° C. and selectively adsorb CO₂ in presence of other gases, in particular water vapor. The sorbent must also have relatively fast kinetics and cyclic stability over many adsorption/desorption cycles. Several review papers outline the various sorbent options for SMR, including calcium oxides, lithium zirconate and hydrotalcites [40, 41]. Though possessing high CO₂ capacity, CaO has poor cyclic stability and is more suited for temperature swing adsorption, requiring high regeneration temperatures. Lithium zirconate similarly is more suited for TSA, and it also suffers from relatively slow kinetics which is not considered in this paper but is an important consideration. Hydrotalcites have lower CO₂ capacities than the other options, but they are well suited for PSA and have excellent cyclic stability and adequate kinetics in the 400-600° C. temperature range.

The CO₂ adsorption properties of hydrotalcite-like compounds are sensitive to their preparation, in particular the Mg/Al ratio and degree of impregnation with alkali metals such as potassium or cesium carbonate [42]. Because the capacity is specific to the preparation method, many studies have reported variations in sorption capacity and other characteristics [31, 43-47]. Of these, only one measured the sorption isotherm beyond a CO₂ pressure of 1 bar, probably because higher CO₂ pressures are not relevant to conventional flow-through SMR reactors. However, data in this pressure range is critical for the CHAMP-SORB reactor, which can achieve high CO₂ partial pressure conditions as the CH₄ and H₂O are depleted by the SMR reaction and H₂ is removed from the reaction chamber via membrane permeation. The sorption isotherm reported by Lee et al. contains data up to 3 bar and is of Type IV, owing to a proposed mechanism which combines monolayer adsorption with a multi-layer chemical complexation reaction [44]. Because it contains data at the required high CO₂ partial pressures, this isotherm is utilized in the CHAMP-SORB cyclic calculations are provided.

### Results and Discussion

As outlined in the introduction, two key performance metrics for a small-scale distributed reactor, such as the CHAMP-SORB, are thermal (energy) efficiency and volumetric yield density. The thermal efficiency calculation is based on the ratio of heating values of the H₂ product to the CH₄ fuel, with the required heat and work inputs during all stages of the CHAMP-SORB cycle also accounted for (note that all calculations follow a sign convention that the work input is negative):

$${η}_{t h} = \frac{{LHV}_{{H}_{2}} \cdot {N}_{{H}_{2} , perm}}{{LHV}_{C {H}_{4}} \cdot {N}_{C {H}_{4} , 1} + Σ {Q}_{i n} - Σ {W}_{b , out}} \qquad ( 10 )$$

The energy required to increase the temperature and pressure of the initial mixture of liquid H₂O and gaseous CH₄ from a standard state (25° C., 1 bar) to the elevated reaction temperature and pressure are included in the heat and work components of Eq. (10, Example 1) [48]. The energy penalty associating with generating steam can become a significant factor in the overall thermal efficiency of the process, as the enthalpy of vaporization of one mole of liquid water at STP is ca. 20% of the endothermic heat of the reverse methanation reaction for one mole of CH₄ [26]. The hydrogen yield density is defined as the amount of H₂ permeated through the membrane in a given cycle divided by the maximum volume of the system. The maximum volume occurs at state 2 in FIG. 2.3a, because the reactor contains the largest amount of gas species at this point (the final volume of the low pressure desorption step is constrained to match this volume). Both the volume of gas and the solid volume of the sorbent are included when determining the maximum volume for the yield density calculation:

Vₘₐₓ=V₂=ΣⱼN_{j,2}ν_{j,2}(T_{r×n},P_{r×n})+(1−εₜ)·m_{sorb}/ρ_{sorb} (11)

where εₜ is the total porosity and ρ_{sorb} is the density of the hydrotalcite sorbent taken from Ding and Alpay [43], and ν_{j,2} is the specific volume of species j at the reaction (state 2) temperature and pressure.

Two additional metrics that are considered in assessing the CHAMP-SORB performance are hydrogen yield efficiency and CH₄ conversion. The yield efficiency is defined as the actual amount of H₂ permeated through the reactor divided by the maximum possible H₂ yield if all the carbon in the introduced CH₄ were oxidized to CO₂ (as opposed to some CO), which according to the stoichiometry of Eq. (3, Example 1) is four times the number of moles of CH₄ fed. The CH₄ conversion is defined in a traditional sense of moles reacted divided by moles fed; however, it is important to note that when part of the exhaust gas mixture from the previous cycle is recycled, the moles of CH₄ fed only includes the quantity of new fuel that is added (N_{CH}_{₄}_{,1}), not the total moles of fuel present after recycle (N_{CH}_{₄}_{,2}). As a result, the general expression for CH₄ conversion is:

$${X}_{C {H}_{4}} = \frac{{N}_{C {H}_{4} , 2} - {N}_{C {H}_{4} , 3}}{{N}_{C {H}_{4} , 1}} \qquad ( 12 )$$

### CHAMP-SORB Performance Without Fuel Recycling

The first case considered is for baseline operation with no exhaust gas recirculation (recycling) from the previous cycle. If this is the case, states 1 and 2 in FIG. 2.3 are identical (N_{j,1}=N_{j,2}). FIG. 2.5 is a representative plot that shows how the thermal efficiency, hydrogen yield density, yield efficiency and conversion vary with S/C ratio at a fixed reaction temperature, pressure and mass of sorbent.

As expected from the Le Chatelier's principle, operating with more steam has a favorable impact on CH₄ conversion. Conversion monotonically increases with S/C ratio, an effect that is particularly pronounced for S/C ratios less than 3. Yield efficiency, however, trends closely with CH₄ conversion at low S/C ratios but reaches a maximum and actually tails off at S/C ratios greater than 4. This is due to a dilution effect of excess steam in the reactor chamber: even as more H₂ is produced at higher levels of CH₄ conversion, the hydrogen partial pressure is reduced due to an accumulation of non-permeating, non-adsorbing species in the chamber such that the additional H₂ cannot permeate out of the reactor. The dilution effect at high S/C ratios has a more pronounced effect on the hydrogen yield density due an extra volume required for additional steam in the feed, with yield density tailing off significantly with additional steam above a S/C ratio of 2. Operating at low S/C ratios, where H₂ O becomes the limiting reactant, is also detrimental to yield density. As such, the optimal S/C ratio for hydrogen yield density is approximately 2, which corresponds to the stoichiometry of the combined SMR reaction given by Eq. (3, Example 1).

Determining the optimal S/C ratio for maximum thermal efficiency is not as straightforward as matching the stoichiometry of the combined SMR reaction for maximum yield density. The increase in conversion/yield efficiency with excess steam and the energetic penalty associated with generating steam are competing factors which lead to a maximum thermal efficiency at a S/C ratio of 2.8 for the conditions of FIG. 2.5. Below this optimal S/C ratio, operating with additional steam is favorable because the lower heating value of the extra H₂ produced outweighs the extra energy input required. Operating above the optimal S/C ratio, however, yields increasingly less H₂ and the energetic cost of vaporizing additional water decreases the overall cycle's thermal efficiency.

Because the CHAMP-SORB reactor thermal efficiency and H₂ yield density analysis shows favorable operation at lower S/C ratios than typically found in industrial or sorption-enhanced SMR applications, it is important to consider the potential issue of catalyst deactivation through carbon deposition [49]. Carbon deposition on a catalyst can occur at high temperatures through the endothermic decomposition of methane (CH₄ [symbol] C+2H₂) and at lower temperatures by the exothermic Boudouard reaction (2CO [symbol] C+CO₂) [50]. Methane decomposition is not likely at the lower CHAMP-SORB operating temperatures, but the possibility of low temperature carbon deposition through the Boudouard reaction is possible and more likely to occur at lower S/C ratios [25]. Snoeck et al. experimentally determined an expression for the “coking threshold” (i.e., the ratio of CO₂ to CO concentrations above which the net rate of carbon formation becomes zero) which can be used to determine a critical S/C ratio below which there will be a risk of catalyst deactivation through coking [51]. For the conditions of FIG. 2.5, this coking threshold corresponds to a S/C ratio of 1.75. It can therefore be concluded that it is possible to operate the CHAMP-SORB at S/C ratios low enough to optimize H₂ yield density without risking coking of the catalyst. While this result is specific to the conditions of FIG. 2.5, the coking threshold is monitored during all calculations presented in the following sections and is determined to be sufficiently low in all of these cases to not be a limiting factor in optimization.

FIG. 2.6A-C summarize the simultaneous impact of varying the S/C ratio and amount of sorbent on the two key performance metrics, thermal efficiency and hydrogen yield density, at a temperature of 400° C. and pressure of 5 bar. The solid curves in FIG. 2.6A indicate lines of constant sorbent mass (per mole of CH₄ fed), while dashed curves are lines of constant S/C ratio. The same trend is seen as in FIG. 2.5, with increasing thermal efficiency and yield density at S/C ratios less than 2, followed by a region of decreasing yield density but increasing thermal efficiency at intermediate S/C ratios, and finally decreasing both the yield density and thermal efficiency at high S/C ratios. It can also be seen in FIG. 2.6A that the S/C ratio corresponding to maximum yield density (marked by circles in the plot) always occurs at or just slightly below 2 regardless of sorbent amount. This is in contrast to the S/C ratio corresponding to maximum thermal efficiency (marked by crosses), which decreases with increasing sorbent amount because the increased capacity to selectively remove CO₂ reduces the amount of required excess steam to enhance the conversion. The diminishing returns associated with including additional sorbent, the reasons for which were discussed , can also be seen in FIG. 2.6B and FIG. 2.6C, as increasingly more sorbent is required to provide the same benefit in thermal efficiency and yield density. The thermal efficiency and yield density both increase with additional sorbent at low sorbent levels; however, at very high sorbent amounts (greater than 4 kg/mol CH₄), the yield density can actually decrease with increasing sorbent mass. This occurs specifically at low S/C ratios and is due to the fact that the volume occupied by the sorbent becomes significant relative to the volume of gas in the reactor.

For each specific sorbent mass, the point corresponding to maximum thermal efficiency is labeled with an “x” and maximum yield density with an “o.” The loci of these points are plotted on FIG. 2.6B and FIG. 2.6C, illustrating the impact of optimizing S/C ratio for thermal efficiency versus hydrogen yield density on each of these parameters, with additional data included beyond 4 kg/mol of sorbent. While FIG. 2.6B shows that thermal efficiency continues to monotonically increase with increasing amount of sorbent, according to FIG. 2.6C hydrogen yield density eventually tails off at high sorbent loadings regardless of whether the S/C ratio is chosen to maximize thermal efficiency or yield density.

CHAMP-SORB Reactor Performance with Fuel Recycling

At the end of the reaction/permeation/adsorption step, the residual gas in the reactor consists of some unreacted CH₄ as well as trace CO and unpermeated H₂. All of these are valuable, energy-carrying products, and because most of the hydrogen product is already separated from this mixture it is possible to recycle the residual gas from the CHAMP-SORB reactor exhaust to improve fuel utilization. To model this “closed-loop” mode of operation with product recycling, a recycle fraction (f), defined as the percentage of gas at the end of the reaction step that is recycled (N_{j,2}=N_{j,1}+fN_{j,3}), is introduced. The recycle fraction can take values between zero (no recycle) and unity (full recycle). In the case of full recycle, the reactor fully converts all CH₄ and H₂O introduced and outputs pure H₂ during the reaction step and pure CO₂ when the chamber is exhausted after the desorption step, resulting in a “closed-loop” operation.

FIG. 2.2 illustrates the impact of increasing the recycle fraction for a CHAMP-SORB cycle at 400° C., 5 bar with a specific sorbent mass of 1 kg/mol CH₄ while changing the S/C ratio. The thermal efficiency versus hydrogen yield density curve for f=0 in FIG. 2.2A matches its counterpart in FIG. 2.6A, but as the recycle fraction is increased the curves gradually flatten out. The reason for this flattening is that the impact of lower conversion and hydrogen yield on thermal efficiency penalty at low S/C ratios is “softened” due to recycling of unconverted CH_{4 ,} as opposed to wasting it by exhausting without recycle. Similarly, the drop off in thermal efficiency at high S/C ratios is less severe with fuel recycling because a portion of the excess steam is carried over from the previous cycle and less energy of vaporization is required to generate new steam. As the regeneration fraction is increased from 0 to 1, the general trend is that thermal efficiency increases while hydrogen yield density decreases due to the added volume occupied by the recycled gas and carried over through the cycle. This tradeoff is further illustrated in FIG. 2.2B, which depicts thermal efficiency and corresponding hydrogen yield density as a function of recycle fraction where at all points the S/C ratio is chosen to optimize efficiency.

When the full amount of residual gas is carried over to the next cycle (i.e., f=1.0), the thermal efficiency becomes a constant value regardless of S/C ratio. This result can be understood by recognizing that the amount of gaseous CO₂, CO and H₂ must be equal at the beginning and end of the reaction/permeation/adsorption step (states 2 and 3, respectively, in FIG. 2.3A) during cyclic operation because only CH₄ and H₂O are added to the reactor from one cycle to the next. To keep the CO quantity constant, the reverse methanation and WGS reactions must proceed to equal extents because carbon monoxide is neither permeated nor adsorbed out from the reaction chamber. As such, the net overall reaction must match that of Eq. (3, Example 1), and therefore all the CO₂ and H₂ produced must be removed from the gas phase by adsorption and permeation, respectively, for their quantities to remain equivalent from state 2 to 3. Ultimately, this fixes the proportion of permeated H₂ to added (new fuel increment) CH₄ (4:1) and H₂O (2:1) for each CHAMP-SORB cycle, regardless of the operating S/C ratio after the recycled gas is introduced to the chamber at the start of the reaction/permeation/adsorption step. As a result, the thermal efficiency approaches a fixed value with full regeneration, as the heating value of CH₄ along with the heat required to preheat the fuel and maintain isothermal conditions during cyclic operation are always held in fixed proportion relative to the heating value of H₂ that is permeated from the reactor.

The reasoning above holds true regardless of sorbent mass, so it is expected that this constant thermal efficiency with full regeneration should remain unchanged with varying sorbent amount at a given reaction temperature and pressure. This is confirmed by the results in FIG. 2.8, which is a regime map of thermal efficiency versus hydrogen yield density for varying the sorbent mass and recycle fraction (with the S/C ratio implicitly varied at each data point to maximize thermal efficiency). The curve for 100% recycle is not plotted because the optimal S/C ratio for maximum thermal efficiency is arbitrary when the efficiency is constant, but the curve for 99.9% shows that the thermal efficiency reaches a constant value equal to that of FIG. 2.2A for all non-zero sorbent amounts.

Moving along lines of constant recycle fraction in FIG. 2.8, an increase in the sorbent amount increases both thermal efficiency and hydrogen yield density until the volume occupied by the sorbent becomes significant relative to the gas volume of the reactor chamber. Beyond this point additional sorbent continues to increase thermal efficiency while hurting yield density, in agreement with previously observed trends. The sorbent mass at which hydrogen yield density is negatively impacted does grow, however, with increasing recycle fraction because the added volume of the recycled gases delays the deleterious effect of solid volume occupied by the sorbent. Another important result of FIG. 2.8 is that the thermal efficiency's benefit of exhaust recycling is only present when there is some non-vanishing amount of sorbent. This is because without a sorbent to perturb the equilibrium state of the recycled gases, there is no conversion enhancement associated with recycling. Therefore, adding an increasing amount of exhaust gas in the absence of a sorbent only serves to decrease the hydrogen yield density while keeping thermal efficiency constant. Lastly, as more sorbent is added to the reactor an increasingly smaller fraction of residual products needs to be recycled in order to achieve the same thermal efficiency, while the associated hydrogen yield density penalty becomes lessened.

### Conclusions

A new class of variable volume batch-membrane reactor with integrated CO₂ sorption, termed CHAMP-SORB, is introduced to produce hydrogen from methane feedstock with consideration given to constraints imposed by distributed applications if natural gas is used as a primary source of methane. It is shown that both H₂ and CO₂ separation is required to be able to achieve desirable conversion levels at temperatures as low as 400° C. with low S/C ratios, which are desirable for greater thermal efficiency and hydrogen yield density. The CHAMP-SORB reactor has advantages over traditional SE-SMR approaches in that it does not require a purge gas for sorbent regeneration and is more scalable to different hydrogen generation demands; however this comes with a constraint on maximum achievable sorbent utilization because the desorbed CO₂ remains in the reactor as the volume is expanded rather than is continuously purged as is in the case of continuous flow SE-SME reactors. A “closed-loop” mode of the CHAMP-SORB reactor operation with partial or full recycle of unreacted reaction products with recoverable energy content is introduced, which allows one to maximize thermal efficiency and provides a compelling option for applications involving CO₂ capture combined with power (H₂) generation.

Regime maps for the reactor quasi-equilibrium operation of the CHAMP-SORB reactor, with and without product recycle, are reported which explore the tradeoff between thermal efficiency and hydrogen yield density at a given temperature and pressure, as a function of sorbent mass, S/C ratio and recycle fraction. The analysis yielded the following fundamental insights and recommendations:
The optimal S/C ratio in the feed that maximizes hydrogen yield density is approximately 2 regardless of sorbent mass. S/C ratios above 2 are desired for maximum thermal efficiency; however, with increasing sorbent mass less excess steam is required for optimal thermal efficiency because of the incremental equilibrium shift provided by the additional CO₂ sorption.
There is a diminishing return on sorbent utilization and CH₄ conversion enhancement as more sorbent is added due to the nature of sorbent regeneration into a fixed volume environment of the batch reactor without use of an inert carrier gas. Further, initially increasing the sorbent amount increases both thermal efficiency and yield density of the variable-volume batch reactor, but eventually yield density suffers when the fraction of reactor volume occupied by adsorbent becomes significant relative to the gas volume.
Increasing “degree of recycling”, i.e., the fraction of unreacted reactants and un-separated products at the end of each cycle that is fed back to the reactor for the next consecutive cycle, increases thermal efficiency of the process up to its maximum at 100% recycling, but there is an associated reduction in hydrogen yield density due to a carry-over volume associated with the recycled, rather than simply exhausted, product stream. Importantly, the improvement in process thermal efficiency is not only due to mitigation of a waste of unreacted fuel especially at low S/C ratios, but also owes to a decrease in the energy input required for extra steam production especially at high S/C ratios when the fuel conversion is intrinsically high.
The thermal efficiency benefit of incorporating recycling is only present when CO₂ sorption is incorporated into the CHAMP reactor operation. As more sorbent is added, a lesser degree of recycling is required to achieve a desired level of thermal efficiency, albeit at the expense of simultaneous reduction in hydrogen yield density.
As the recycle fraction approaches unity, the thermal efficiency converges to a constant value, irrespective of either the sorbent mass or post-recycle S/C ratio, because H₂ and CO₂ are produced in a fixed proportion relative to the consumed CH₄ and H₂O.

The thermodynamic analysis in this paper shows that CHAMP-SORB cycle is a viable option for low temperature distributed production of hydrogen via sorption-enhanced steam methane reforming, and establishes a thermodynamic envelope for ideal reactor performance. With inclusion of reaction kinetics and heat/mass transfer effects, a comprehensive analytical methodology for the CHAMP-SORB class of reactors should allow determination of practically-relevant performance characteristics, such as hydrogen yield density, reactor throughput and scalability, to further assess the application potential of this new fuel processing approach.

### References for Example 1

[1] Paltsev S, Jacoby H D, Reilly J M, Ejaz Q J, Morris J, O'Sullivan F, et al. The future of US natural gas production, use, and trade. Energy Policy. 2011; 39:5309-21.
[2] Kargbo D M, Wilhelm R G, Campbell D J. Natural gas plays in the Marcellus shale: Challenges and potential opportunities. Environ Sci Technol. 2010; 44:5679-84.
[3] Fletcher J, Callaghan V. Evaluation Cost of Distributed Production of Hydrogen from Natural Gas-Independent Review. NREL/BK-150-40382, October; 2006.
[4] Garland N L, Papageorgopoulos D C, Stanford J M. Hydrogen and Fuel Cell Technology: Progress, Challenges, and Future Directions. Energy Procedia. 2012; 28:2-11.
[5] Kelly N A, Gibson T L, Cai M, Spearot J A, Ouwerkerk D B. Development of a renewable hydrogen economy: Optimization of existing technologies. Int J Hydrogen Energy. 2010; 35:892-9.
[6] Rosen M A. Advances in hydrogen production by thermochemical water decomposition: A review. Energy. 2010; 35:1068-76.
[7] Adams B D, Chen A. The role of palladium in a hydrogen economy. Materials Today. 2011; 14:282-9.
[8] Zuttel A, Borgschulte A, Schlapbach L. Hydrogen as a future energy carrier: John Wiley & Sons; 2011.
[10] Lattin W C, Utgikar V P. Transition to hydrogen economy in the United States: A 2006 status report. Int J Hydrogen Energy. 2007; 32:3230-7.
[11] Barreto L, Makihira A, Riahi K. The hydrogen economy in the 21st century: a sustainable development scenario. Int J Hydrogen Energy. 2003;28:267-84.
[12] Lee K B, Beaver M G, Caram H S, Sircar S. Novel thermal-swing sorption-enhanced reaction process concept for hydrogen production by low-temperature steam-methane reforming. Ind Eng Chem Res. 2007; 46:5003-14.
[13] Damm D L, Fedorov A G. Conceptual study of distributed CO₂ capture and the sustainable carbon economy. Energy Conyers Manage. 2008; 49:1674-83.
[14] Baade W F, Parekh U N, Raman V S. Hydrogen. Kirk-Othmer Encyclopedia of Chemical Technology: John Wiley & Sons, Inc.; 2000.
[14] Rostrup-Nielsen J R. Production of Synthesis Gas. Catal Today. 1993; 18:305-24.
[15] Xu J G, Froment G F. Methane steam reforming, methanation and water-gas shift 1. Intrinsic kinetics. AIChE J. 1989; 35:88-96.
[16] Harrison D P. Sorption-enhanced hydrogen production: A review. Ind Eng Chem Res. 2008; 47:6486-501.
[17] Okada O, Yokoyama K. Development of polymer electrolyte fuel cell cogeneration systems for residential applications. Fuel Cells (Weinheim, Ger). 2001; 1:72-7.
[18] Barelli L, Bidini G, Gallorini F, Servili S. Hydrogen production through sorption-enhanced steam methane reforming and membrane technology: A review. Energy. 2008; 33:554-70.
[19] Ritter J A, Ebner A D. State-of-the-art adsorption and membrane separation processes for hydrogen production in the chemical and petrochemical industries. Separ Sci Technol. 2007; 42:1123-93.
[20] Uemiya S, Sato N, Ando H, Matsuda T, Kikuchi E. Steam reforming of methane in a hydrogen-permeable membrane reactor. Appl Catal. 1991; 67:223-30.
[21] Shu J, Grandjean B P A, Kaliaguine S. Methane steam reforming in asymmetric Pd—Ag and Pd—Ag/porous SS membrane reactors. Appl Catal A-Gen. 1994; 119:305-25.
[22] Marin P, Patino Y, Diez F V, Ordonez S. Modelling of hydrogen perm-selective membrane reactors for catalytic methane steam reforming. Int J Hydrogen Energy. 2012; 37:18433-45.
[23] Saric M, van Delft Y C, Sumbharaju R, Meyer D F, de Groot A. Steam reforming of methane in a bench-scale membrane reactor at realistic working conditions. Catal Today. 2012; 193:74-80.
[24] Hufton J R, Mayorga S, Sircar S. Sorption-enhanced reaction process for hydrogen production. AlChE J. 1999; 45:248-56.
[25] Ding Y, Alpay E. Adsorption-enhanced steam-methane reforming. Chem Eng Sci. 2000; 55:3929-40.
[26] Reijers H T J, Valster-Schiermeier S E A, Cobden P D, van den Brink R W. Hydrotalcite as CO₂ sorbent for sorption-enhanced steam reforming of methane. Ind Eng Chem Res. 2005; 45:2522-30.
[27] Lee K B, Beaver M G, Caram H S, Sircar S. Effect of reaction temperature on the performance of thermal swing sorption-enhanced reaction process for simultaneous production of fuel-cell-grade H₂ and compressed CO₂ from synthesis gas. Ind Eng Chem Res. 2008; 47:6759-64.
[28] Beaver M G, Caram H S, Sircar S. Sorption enhanced reaction process for direct production of fuel-cell grade hydrogen by low temperature catalytic steam-methane reforming. J Power Sources. 2010; 195:1998-2002.
[29] Halabi M H, de Croon M H J M, van der Schaaf J, Cobden P D, Schouten J C. A novel catalyst-sorbent system for an efficient H₂ production with in-situ CO₂ capture. Int J Hydrogen Energy. 2012; 37:4987-96.
[30] Halabi M H, de Croon M H J M, van der Schaaf J, Cobden P D, Schouten J C. Kinetic and structural requirements for a CO₂ adsorbent in sorption enhanced catalytic reforming of methane—Part I: Reaction kinetics and sorbent capacity. Fuel. 2012; 99.
[31] Halabi M H, de Croon M H J M, van der Schaaf J, Cobden P D, Schouten J C. High capacity potassium-promoted hydrotalcite for CO₂ capture in H₂ production. Int J Hydrogen Energy. 2012; 37.
[32] Harale A, Hwang H T, Liu P K T, Sahimi M, Tsotsis T T. Experimental studies of a hybrid adsorbent-membrane reactor (HAMR) system for hydrogen production. Chem Eng Sci. 2007; 62:4126-37.
[33] Harale A, Hwang H T, Liu P K T, Sahimi M, Tsotsis T T. Design aspects of the cyclic hybrid adsorbent-membrane reactor (HAMR) system for hydrogen production. Chem Eng Sci. 2010; 65:427-35.
[34] Damm D L, Fedorov A G. Comparative assessment of batch reactors for scalable hydrogen production. Ind Eng Chem Res. 2008; 47:4665-74.
[35] Damm D L, Fedorov A G. Batch reactors for hydrogen production: Theoretical analysis and experimental characterization. Ind Eng Chem Res. 2009; 48:5610-23.
[36] Twigg M. Catalyst Handbook Wolfe. New York. 1989.
[37] Marcano J G S, Tsotsis T T. Catalytic membranes and membrane reactors. Weinheim, Germany: Wiley-VCH; 2002.
[38] Brunauer S, Deming L S, Deming W E, Teller E. On a theory of the van der Waals adsorption of gases. J Am Chem Soc. 1940; 62:1723-32.
[39] Carvill B T, Hufton J R, Anand M, Sircar S. Sorption-enhanced reaction process. AIChE J. 1996; 42:2765-72.
[40] Choi S, Drese J H, Jones C W. Adsorbent materials for carbon dioxide capture from large anthropogenic point sources. ChemSusChem. 2009; 2:796-854.
[41] Lee K B, Beaver M G, Caram H S, Sircar S. Reversible chemisorbents for carbon dioxide and their potential applications. Ind Eng Chem Res. 2008; 47.
[42] Oliveira E L G, Grande C A, Rodrigues A E. CO₂ sorption on hydrotalcite and alkali-modified (K and Cs) hydrotalcites at high temperatures. Sep Purif Technol. 2008; 62:137-47.
[43] Ding Y, Alpay E. Equilibria and kinetics of CO₂ adsorption on hydrotalcite adsorbent. Chem Eng Sci. 2000; 55:3461-74.
[44] Lee K B, Verdooren A, Caram H S, Sircar S. Chemisorption of carbon dioxide on potassium-carbonate-promoted hydrotalcite. J Colloid Interf Sci. 2007; 308:30-9.
[45] Ebner A D, Reynolds S P, Ritter J A. Nonequilibrium kinetic model that describes the reversible adsorption and desorption behavior of CO₂ in a K-promoted hydrotalcite-like compound. Ind Eng Chem Res. 2007; 46:1737-44.
[46] Du H, Ebner A D, Ritter J A. Pressure dependence of the nonequilibrium kinetic model that describes the adsorption and desorption behavior of CO₂ in K-promoted hydrotalcite like compound. Ind Eng Chem Res. 2010; 50:412-8.
[47] Hutson N D, Attwood B C. High temperature adsorption of CO₂ on various hydrotalcite-like compounds. Adsorption. 2008; 14:781-9.
[48] Lutz A E, Bradshaw R W, Keller J O, Witmer D E. Thermodynamic analysis of hydrogen production by steam reforming. Int J Hydrogen Energy. 2003; 28:159-67.
[49] Bartholomew C H. Mechanisms of catalyst deactivation. Appl Catal A-Gen. 2001; 212:17-60.
[50] Rostrup-Nielsen J R, Anderson J, Boudart M. Catalysis science and technology, vol. 5. by JR Anderson and M Boudart, Springer, Berlin. 1984.
[51] Snoeck J W, Froment G F, Fowles M. Steam/CO₂ reforming of methane. Carbon filament formation by the boudouard reaction and gasification by CO₂, by H₂, and by steam: Kinetic study. Ind Eng Chem Res. 2002; 41:4252-65.

### Example 2

Although abundant petroleum and coal have enabled the production of affordable primary power and transportation fuels over the past century, the recent emergence of natural gas as a significant fossil fuel resource has dramatically changed the energy landscape.¹ With its favorable hydrogen-to-carbon ratio coupled with recently developed techniques to tap vast reserves that were previously not economically viable, natural gas has been touted by many as a bridge fuel to a low-carbon energy future and as a potential means to minimize dependence on foreign oil for transportation fuel.^{2,3} To make full use of this promising resource, new chemical conversion processes that are optimized for natural gas feedstock must be developed. A process that can efficiently produce hydrogen in a small-scale, distributed fashion by steam reforming of natural gas is one such technology that would have a far-reaching impact, as it could eliminate the requirement for a large-scale hydrogen delivery infrastructure and aid the diffusion of hydrogen-powered technology into society.^{4,5} Such a process could effectively utilize the existing natural gas distribution infrastructure and would pair well with localized natural gas production from shale gas wells.¹

Hydrogen production from natural gas feedstock via the steam-methane reforming (SMR) process is a mature industrial technology;^{8,7} yet miniaturizing this process for distributed production has proven problematic. Owing to the strongly endothermic nature of the process, reaction temperatures in excess of 900° C. are traditionally employed in large-scale SMR reactors to overcome the thermodynamic limitations of the process. For a distributed reactor system, a maximum operating temperature below 500° C. is desired to improve safety and reduce material cost and preheating energy requirements. Furthermore, in a conventional large-scale fuel processing plant, multiple sequential unit operations are required after the primary reforming reaction step to first convert unwanted CO into H₂ through the water gas shift (WGS) reaction, and then purify the H₂ product using various separation techniques.⁸ In addition to resulting in an excessively large footprint, with decreasing system size the sequential unit operation approach has an increasingly deleterious effect on performance because the relative impact of system losses and cost of balance-of-plant components become more pronounced.⁹ Lastly, although the stoichiometry of the overall SMR process only requires a 2:1 molar H₂O to CH₄ feed (S/C ratio), industrial SMR processes frequently operate at S/C ratios of between 3-6:1 to enhance CH₄ conversion and to minimize catalyst coking.⁸ In distributed applications, operating at S/C ratios closer to 2:1 are desired as excess steam is less readily available, is energetically costly, and reduces the volumetric H₂ yield density.

Combined reaction-separation approaches are a promising means to overcome the SMR process scale-down limitations.¹⁰-16 By Le Chatelier's principle, in situ removal of H₂ and/or CO₂ from the reactor shifts equilibrium toward greater fuel conversion and H₂ yield, potentially producing a suitable level of conversion at much lower temperature and allowing removal of subsequent WGS and purification unit operations. To this end, this PhD research focuses on the advancement of the CO₂/H₂ Active Membrane Piston (CHAMP) variable volume, batch-membrane reactor concept to incorporate selective CO₂ adsorption and enable distributed H₂ production from natural gas feedstock. The CHAMP reactor, operating in a cycle similar to the Internal Combustion (IC) engine, has proven capable of dynamically maintaining optimal reaction conditions for transport of reactants to the catalyst, reaction kinetics at the catalyst, and H₂ membrane separation. Specifically, as fuel is depleted and reactor pressure is reduced due to permeation, strategic compression using the “active” piston is employed to increase the concentration of the remaining fuel and hydrogen, thereby providing additional driving force for reaction and permeation. Because the residence time and thermodynamic state (pressure and temperature) in the variable-volume batch reactor can be actively controlled to allow reaction and separation to proceed at an enhanced rate and to a desired level of completion, the CHAMP offers flexibility for various desired H₂ throughputs not possible with traditional large-scale steady-state flow reactors. Previously, theoretical and experimental studies on CHAMP performance were carried out using only H₂ separation and with methanol (CH₃OH) as feedstock due to its relatively low reaction temperature, which established the fundamental feasibility and promise of the approach.^{17,18}

This Example focuses on developing the CHAMP reactor concept further by (1) incorporating CO₂ adsorption to complement the H₂ membrane separation and (2) reforming CH₄ as opposed to CH₃OH. This enhanced reactor concept, termed CHAMP-SORB, incorporates sorbent regeneration steps in its operating cycle, thereby preventing eventual saturation of the sorbent and enabling CH₄ conversion enhancement for repeated cyclic operation. In particular, the active regeneration steps will deviate from the traditional pressure swing adsorption (PSA) process, as partial pressure of the adsorbed species is reduced by expanding the reactor volume as opposed to purging a fixed bed with an inert sweep gas. This sorbent regeneration method is desirable because it minimizes dilution of CO₂ during desorption, making it more energy efficient to capture.

The overarching goal of the proposed work is to develop a practical and scalable method of producing hydrogen at the point of use for fuel cell vehicles and residential power applications. Distributed hydrogen production, also known as forecourt production, is a promising approach to overcome one of the primary barriers to a sustainable hydrogen economy: the present lack of a large-scale hydrogen delivery infrastructure. Because the distribution of hydrogen is both costly and technically challenging, at present roughly 95% of worldwide hydrogen production is captive (i.e., production and usage are collocated).¹⁹ Implementation of efficient, small-scale hydrogen production from methane, the primary component of natural gas, at the point of use would allow application of this captive production strategy for residential co-generation^{4,5} and vehicle refueling stations.²⁰

Steam-methane reforming (SMR) is the most prevalent large-scale industrial method of H₂ production, accounting for 95% of production in the United States.^{6,7} The SMR process consists of (1, Example 2) the strongly endothermic reverse methanation reaction, (2, Example 2) the moderately exothermic water gas shift (WGS) reaction, and (3, Example 2) the overall steam methane reforming reaction which is a linear combination of (1, Example 2) and (2, Example 2):

CH₄+H₂O [symbol] 3H₂+CO, ΔH_{298K}=206.1 kJ/mol

CO+H₂O [symbol] H2+CO₂, ΔH_{298K}=−41.2 kJ/mol

CH₄+2H₂O [symbol] 4H₂+CO₂, ΔH_{298K}=164.9 kJ/mol (3)

The three reactions occur in parallel, typically in a packed-bed continuous flow reactor over a nickel catalyst. 21 Because reactions (1, Example 2) and (2, Example 2) are both reversible with opposing heats of reaction (resulting in the forward reaction direction being favored in different temperature ranges), complete conversion of CH₄ into CO₂ and H₂ is not possible at a single operating temperature.⁸ As such, large-scale industrial steam reformers utilize an initial reactor stage that operates at approximately 800-900° C. to promote the forward direction of the strongly endothermic reverse methanation reaction, followed by lower temperature reactor(s) with conditions favorable for the exothermic WGS reaction. Excess steam is also employed, often a steam to carbon (S/C) molar ratio ranging between 3:1 and 6:1, to further shift equilibrium of all three reactions towards greater H₂ production. Final H₂ purification is achieved via pressure swing adsorption or other separation techniques.

With numerous sequential unit operations and the need for high temperature operating conditions, conventional industrial scale SMR is not particularly feasible for localized production of hydrogen from methane at lower (and dynamically variable) throughputs. Such applications place a premium on energy (thermal) efficiency, cost, and minimizing the footprint of the fuel processing strategy.

### Reactor Design:

Combined reaction-separation processes are one promising means to meet the aforementioned process requirements for distributed SMR.^{22,23} In-process removal of H₂ and/or CO₂ from the reactor shifts equilibrium toward greater fuel conversion and H₂ yield and creates conditions in which a suitable level of conversion is achieved at a reduced temperature and without the need for steam in excess of the stoichiometric 2:1 S/C ratio. Furthermore, the in situ separation of H₂ eliminates the need for a separate purification unit by combining this operation within the main reactor. Finally, maintaining an elevated reactor pressure using a variable volume approach allows the driving force for reaction, permeation, and adsorption to be maintained throughout the process. Before designing a specific reactor for low temperature SMR, first the amount of separation required to achieve high CH₄ conversion at low temperature can be estimated in a limiting case (i.e., without consideration of reactor type and ignoring heat/mass transfer effects) by solving the following set of species conservation and thermodynamic equilibrium equations:

$${N}_{j} = {N}_{j}^{0} + ( 1 - {r}_{j} ) {Σ}_{i} {ε}_{i} {v}_{ij} - {N}_{j , perm} \qquad ( 4 )$$

$${K}_{1} ( T ) = \frac{{y}_{{H}_{2}}^{3} {y}_{CO}}{{y}_{C {H}_{4}} {y}_{{H}_{2} O}} \cdot {[ \frac{{P}_{r x n}}{{P}_{r e f}} ]}^{2} \qquad ( 5 )$$

$${K}_{2} ( T ) = \frac{{y}_{{H}_{2}} {y}_{{CO}_{2}}}{{y}_{CO} {y}_{{H}_{2} O}} \qquad ( 6 )$$

$$\begin{matrix}{P}_{{H}_{2} , perm} = {y}_{{H}_{2}} \cdot {P}_{t o t} ( with membrane ) \\ or \\ {N}_{{H}_{2} , perm} = 0 ( without membrane )\end{matrix} \} \qquad ( 7 )$$

Eq. (4, Example 2) represents species conservation during a combined reaction/permeation/adsorption process, where the initial number of moles of each species j, Nⱼ⁰, evolves to a final value Nⱼ. In this equation, rⱼ represents the fraction of produced species j that is adsorbed from the gas phase, εᵢ is the extent of reaction i, νᵢⱼ is the stoichiometric coefficient of the j^{th} component of reaction i, and N_{j,perm} (only non-zero for j=H₂) represents the number of moles of species j that permeates out of the reactor. Eqs. (5, Example 2) and (6, Example 2) represent the chemical equilibrium constraint for the reverse methanation and WGS reactions, respectively, where the equilibrium constants for reverse methanation (K₁) and WGS (K₂) are calculated as function of the reaction temperature using empirical correlations.²⁴ Lastly, if a selectively permeable H₂ membrane is present, the final H₂ partial pressure in the reactor (y_{H}_{₂}·Pₜₒₜ) must be equal to the hydrogen pressure on the permeate side of the membrane (P_{H}_{₂}_{,perm}), or in the case of no H₂ membrane the amount of H₂ permeation becomes zero.

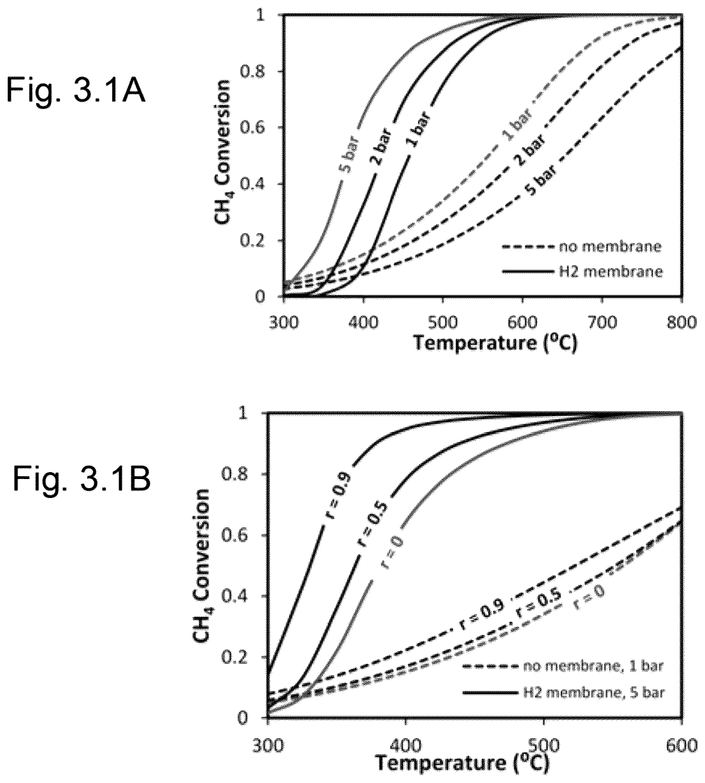

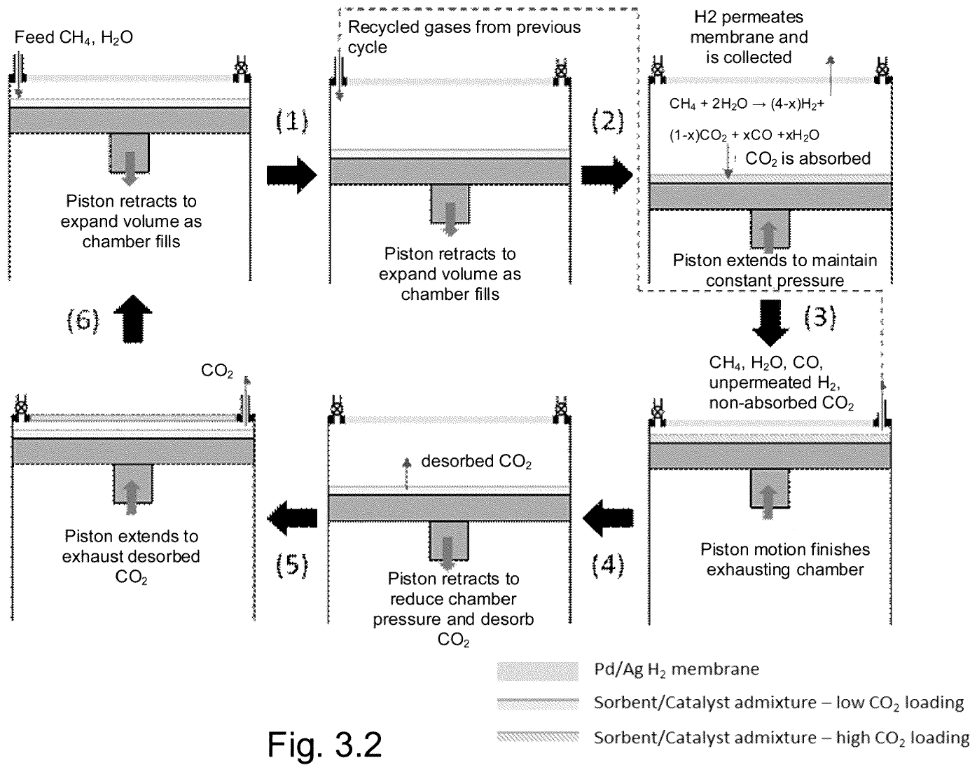

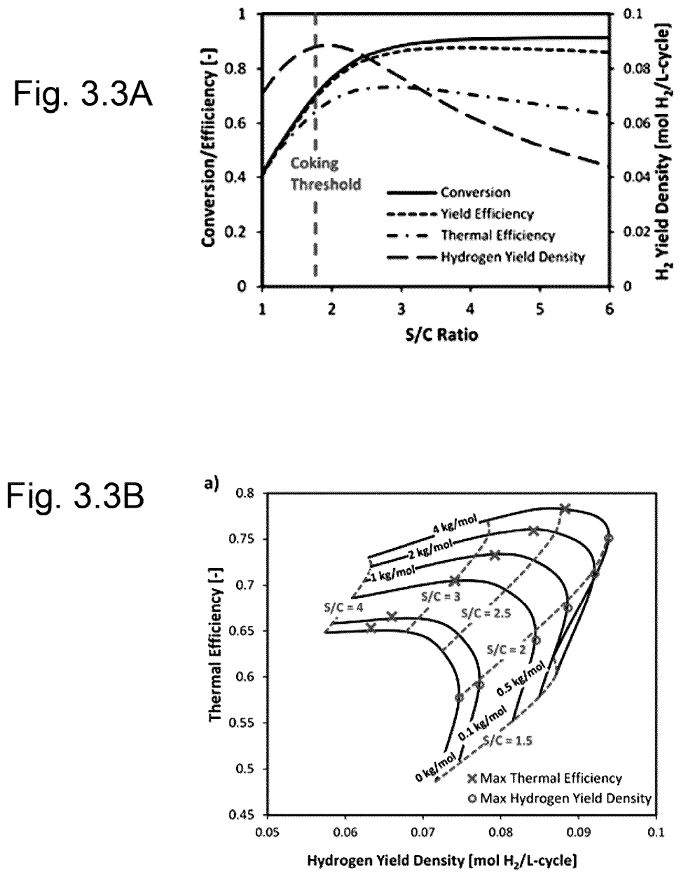

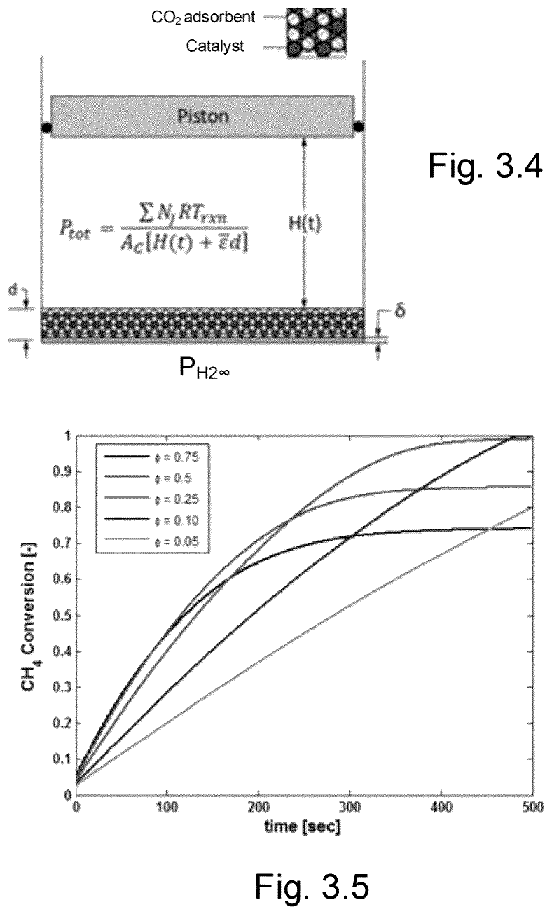

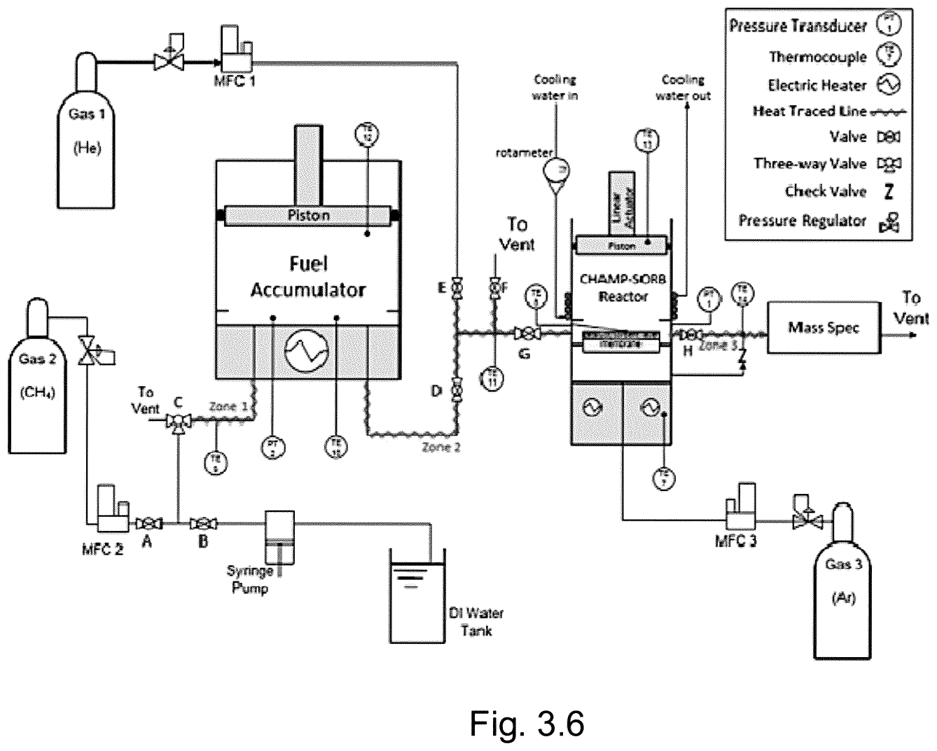

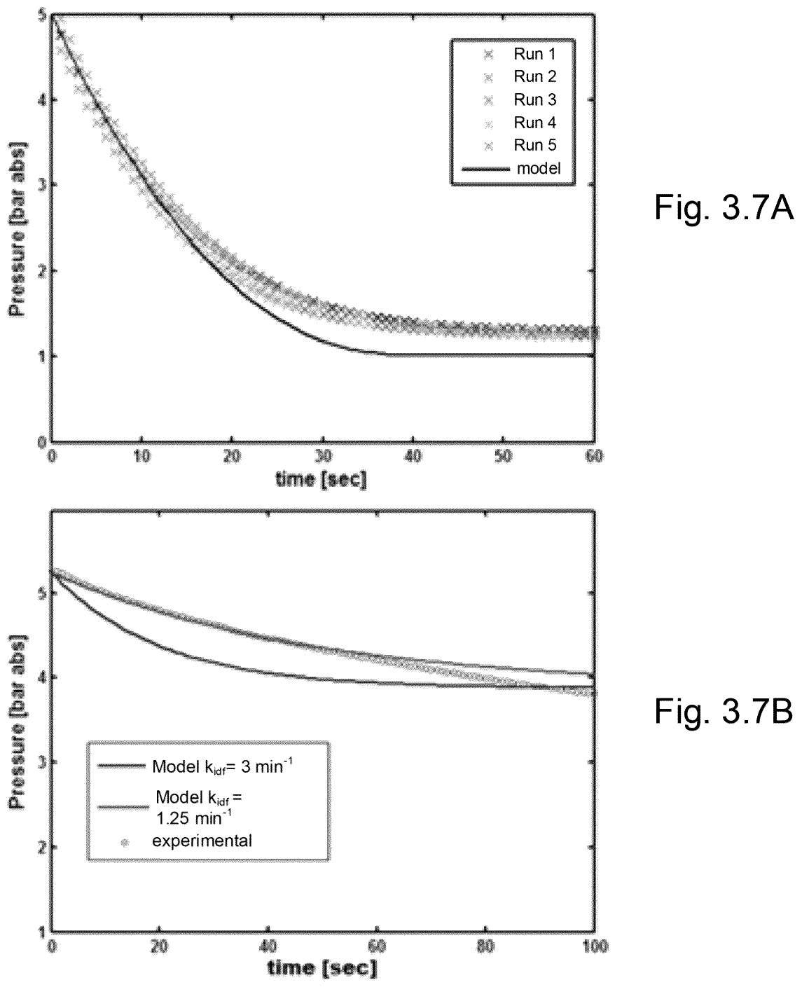

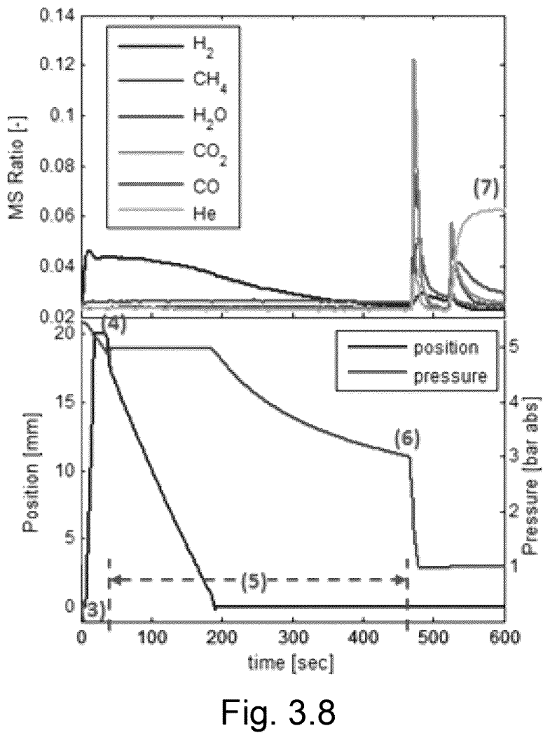

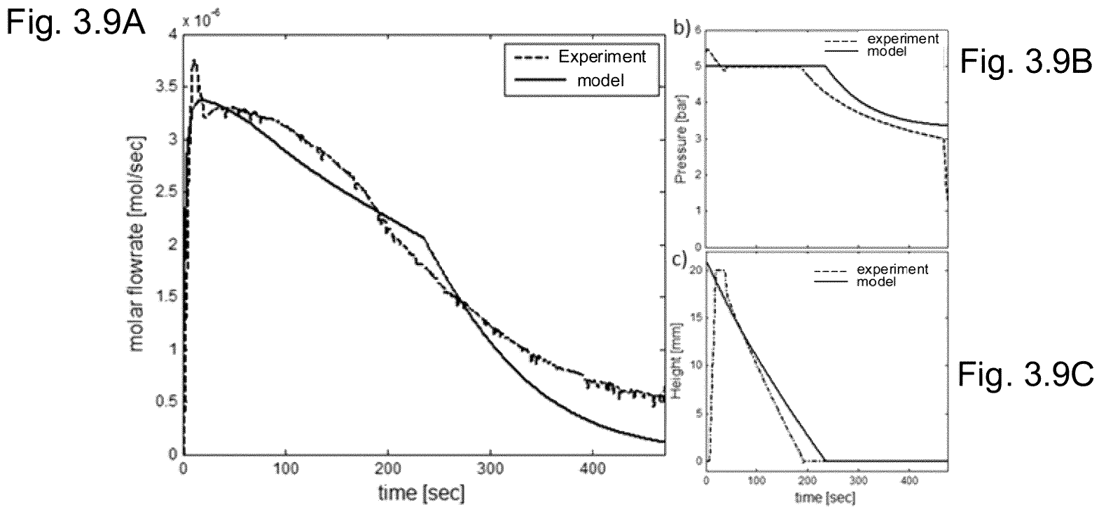

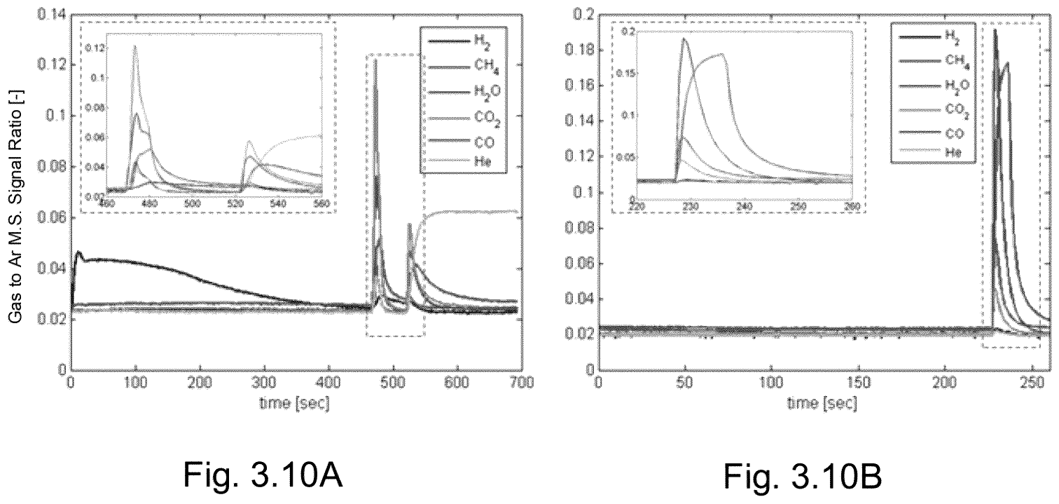

FIG. 3.1A-B show the impact of temperature, pressure, and in situ removal of H₂/CO₂ via membrane permeation and adsorption on the equilibrium conversion of a 2:1 ratio of H₂O:CH₄. In the case of a membrane, the H₂ partial pressure on the permeate side (P_{H}_{₂}_{,perm}) is held constant at 0.2 bar by an inert sweep gas or consumption in an appropriate (electro)chemical device.¹⁷ FIG. 3.1A considers conversion without CO₂ adsorption and illustrates that without a membrane, reaction temperatures in excess of 700° C. are required to achieve a conversion of greater than 90%. However, the same level of conversion can be achieved at ca. 500° C. with a membrane reactor at 5 bar reaction pressure because of the equilibrium shift due to H₂ removal. FIG. 3.1B illustrates that combining 90% CO₂ removal with H₂ membrane separation, a temperature of only 400 ° C. is required to achieve 90% CH₄ conversion. Furthermore, without an H₂ membrane, removing a large fraction of the produced CO₂ does not provide much conversion enhancement at all; it is clear there is a synergistic effect in combining CO₂ sorption with H₂ membrane permeation.

A key takeaway from the SMR thermodynamic equilibrium analysis is that both a hydrogen permeable membrane and CO₂ sorption are required for the CHAMP reactor to achieve a desirable SMR conversion level (>90%) at temperatures as low as 400° C. This insight motivates this research proposal to modify the original CHAMP reactor, which only utilized H₂ membrane separation, to incorporate CO₂ adsorption.

The cyclic CHAMP-SORB reactor, incorporating both an infinitely selective to hydrogen Pd/Ag membrane and CO₂ adsorbent material as guided by the preliminary thermodynamic calculations, is depicted in FIGS. 3.1A and B illustrate graphs of the maximum (equilibrium) CH₄ conversion achievable for a 2:1 S/C ratio batch of fuel for A) with H₂ removal only, and B) with H₂ and CO₂ removal (r=fraction of CO₂ removed from reactor).

FIG. 3.2 illustrates the reactor operates as follows: it is first filled with a mixture of CH₄ and H₂O, as well as recycled products from the previous cycle (if desired). The mixture then undergoes the SMR reaction, which is enhanced by permeation of H₂ through the membrane and adsorption of CO₂. Simultaneously, the piston moves upwards to maintain reactor pressure as H₂ and CO₂ are removed from the gas phase.

After the reaction has proceeded sufficiently, the exhaust valve opens and the upstroke is completed. As denoted by the red dotted line, part or all of the exhaust gases can be recycled to the filling downstroke of the next CHAMP cycle if losses of residual hydrogen and unconverted methane upon exhaust are to be minimized. Once the chamber is exhausted, a second expansion stroke increases the chamber volume to reduce pressure and to facilitate desorption of CO₂, with heat addition (not shown) to maintain temperature during the endothermic desorption process. Lastly a second upstroke exhausts the desorbed CO₂ from the reaction chamber, allowing it to be captured if desired.

While both packed-bed catalytic H₂ membrane reactors^{12,13,16,25} and CO₂ sorption-enhanced reactors^{5,14,15,26-28} have been studied extensively for distributed SMR, relatively little attention has been paid to reactor systems that incorporate combined H₂ membrane separation with CO₂ sorption. Only the work of Harale, et al.^{29,30} considered the combination of both techniques, but it did not utilize a batch process with variable volume to facilitate sorbent regeneration as proposed here.

A series of studies have been conducted thus far to assess the viability of the proposed CHAMP-SORB concept, including thermodynamic analysis, kinetic modeling of an ideal reactor (assuming no transport limitations), and testbed validation of the main components and overall system performance.

### Thermodynamic Modeling

The first step in assessing the viability of the proposed CHAMP-SORB reactor is to establish the thermodynamic bounds for its ideal cyclic operation by performing equilibrium calculations at each of the states 1-6 labeled in FIG. 3.1 illustrates a graph of the maximum (equilibrium) CH₄ conversion achievable for a 2:1 S/C ratio batch of fuel for a) with H₂ removal only, and b) with H₂ and CO₂ removal (r=fraction of CO₂ removed from reactor).

FIG. 3.2 illustrates the assumption that the reaction/permeation/adsorption and desorption steps proceed fully to equilibrium and that sufficient heat is added to maintain isothermal conditions. K₂CO₃-promoted hydrotalcite is chosen as the sorbent for use in the model because of its near-infinite selectivity towards CO₂ adsorption in the presence of steam, and its ability to adsorb at temperatures up to 520° C.³¹⁻³⁴ Full details of the modeling process can be found in our recently published study,³⁵ while here only the key findings are summarized.

Two key performance metrics are utilized to evaluate the performance of the CHAMP-SORB reactor during the thermodynamic modeling: thermal energy efficiency (ηₜₕ) and volumetric H₂ yield density. The thermal efficiency calculation is based on the ratio of lower heating values (LHV) of the H₂ product to the CH₄ fuel. As shown in Eq. (8, Example 2), the required heat and work inputs during all stages of the CHAMP-SORB cycle are included in the efficiency calculation. Included in this is the energy required to increase the temperature and pressure of the initial mixture of liquid H₂O and gaseous CH₄ from a standard state (25° C., 1 bar) to the elevated reaction temperature and pressure.³⁶ Additionally considered are CH₄ conversion as well as H₂ yield efficiency (defined as number of moles of H₂ permeated divided by the maximum possible H₂ yield, or four times the number of initial moles of CH₄ according to the reaction stoichiometry).

$${η}_{t h} = \frac{L H {V}_{{H}_{2}} \cdot {N}_{{H}_{2} , perm}}{L H {V}_{C {H}_{4}} \cdot {N}_{{CH}_{4} , 1} + Σ {Q}_{i n} - Σ {W}_{b , out}} \qquad ( 8 )$$

FIG. 3.3A illustrates the results of the CHAMP-SORB thermodynamic modeling at a given ratio of sorbent to fuel (in this case 1 kg/initial mol CH₄) at 400° C. and 5 bar. Operation at a higher S/C ratio has a favorable impact on CH₄ conversion, which monotonically increases with S/C. Yield efficiency, however, trends closely with CH₄ conversion at low S/C ratios but actually tails off at high S/C as the extra steam in the reactor lowers the H₂ partial pressure, thereby reducing the driving permeation force. H₂ yield density is even more strongly impacted by the dilution effect, as the volume required for additional steam in the feed significantly reduces the yield density as S/C ratio increases above 2. A S/C ratio of 2.8 is required to maximize ηₜₕ, as the increase in conversion gained through a favorable shift in equilibrium due to excess steam and the energetic required to generate that steam are competing factors. Below the optimal S/C ratio of 2.8, increasing the amount of steam present is favorable because the LHV of the extra H₂ produced outweighs the extra energy input required; however, beyond this S/C ratio the additional H₂ production is outweighed by the energetic cost of vaporizing additional H₂O.

FIG. 3.3B shows the impact of varying sorbent amounts on the overall CHAMP-SORB performance. As more sorbent is added, the required S/C ratio to maximize ηₜₕ and H₂ yield density begin to converge (S/C for optimal ηₜₕ decreases from 3.5 to 2.4 with additional sorbent, while the optimal S/C for H₂ yield density remains constant at roughly 2).

### Ideal Reactor Kinetic Modeling

Having established the thermodynamic viability of the CHAMP-SORB reactor concept, the kinetics of chemical reaction, CO₂ adsorption and H₂ permeation must next be considered. An ideal reactor model is developed to better understand the chemical timescales governing the key processes. The following simplifications are made: (1) spatially uniform species concentration, (2) isothermal conditions, (3) negligible intra-particle diffusion limitations (i.e. catalyst effectiveness factor³⁷ of unity), (4) adsorption process can be described by a linear driving force approach,³⁸ and (5) H₂ permeation process is diffusion limited and can be modeled by Sievert's law.^{39,40} The transient reactor behavior can be modeled using a set of coupled ordinary differential equations (9-12, Example 2) and a relationship for total pressure (Pₜₒₜ) from the ideal gas equation of state Eq. (13, Example 2):

$$\frac{d {N}_{j}}{d t} = \overline{ρ} {A}_{c} d ϕ {\sum }_{i = 1}^{3} {v}_{ij} {r}_{i} - \frac{d {N}_{j , p}}{d t} - \overline{ρ} {A}_{c} d ( 1 - ϕ ) \frac{d {q}_{j}}{d t} \qquad ( 9 )$$

$$\frac{d {N}_{{H}_{2} , p}}{d t} = {A}_{c} \frac{{D}_{m e m}}{δ} ( {P}_{{H}_{2}}^{1 / 2} - {P}_{{H}_{2} , ∞}^{1 / 2} ) \qquad ( 10 )$$

$$\frac{d {q}_{{CO}_{2}}}{d t} = ( \overline{ρ} {A}_{c} d ) ( 1 - ϕ ) {k}_{l d f} [ {q}_{e q} - {q}_{{CO}_{2}} ] \qquad ( 11 )$$

$$\frac{d H}{d t} = \frac{{R}_{u} {T}_{r x n}}{{A}_{c} {P}_{t o t}} {\sum }_{j = 1}^{5} \frac{d {N}_{j}}{d t} \qquad ( 12 )$$

$${P}_{t o t} = \frac{\sum {N}_{j} {R}_{u} {T}_{r x n}}{{A}_{c} [ H ( t ) + \overline{ε} d ]} \qquad ( 13 )$$

where dNⱼ/dt is the time-rate of change of each of the 5 species considered (CH₄, H₂O, H₂, CO₂, CO), dN_{j,mp}/dt is the permeation rate of species j (only non-zero for j=H₂), dqⱼ/dt is the rate of adsorption of species j per unit mass of sorbent (only non-zero for j=CO₂), and dH/dt is the piston velocity required to maintain constant pressure. The species generation due to reaction, the first term on the right side of Eq. (9, Example 1), is the product of the mass of the catalyst ([ρ̅A_{c}dϕ], where ρ̅ is the sorbent/catalyst mixture density, A_{c} is the cross sectional area, d is the catalyst/sorbent layer thickness, and ϕ is the ratio of catalyst mass to total sorbent and catalyst mass) with the sum over all reactions of the stoichiometric coefficient of each reaction (μᵢⱼ) and the individual reaction rates (rᵢ). Reaction rates are calculated as functions of temperature and species concentration according to the model of Xu and Froment.^{21,41}

TABLE 1
Ideal kinetic model
simulation parameters

| P₀ | 5 | bar |
|---|---|---|
| Tᵣₓₙ | 400° | C. |
| A_{c} | 2.41 | cm² |
| H₀ | 25 | mm |
| d | 1 | mm |
| δ | 50 | μm |
| Dₘₑₘ | 5.21 × 10⁻⁸ mol | |
| | m · s · bar^{1/2} | |
| P_{H}_{₂}_{,∞} | 0.2 | bar |
| k_{ldf} | 3 | min⁻¹ |

The membrane diffusion coefficient (Dₘₑₘ) is taken from experiments conducted by McLeod et al.⁴² The linear driving force coefficient for adsorption (k_{LDF}) and equilibrium CO₂ loading (q_{eq}) as a function of temperature and CO₂ partial pressure are taken from a study on K₂CO₃-promoted hydrotalcite by Lee et al.³³ These values, as well as those of other design parameters (chosen to match the experimental testbed) are listed in Table 1, Example 2. The preliminary purely kinetic modeling aims to both capture the dynamics of the relevant chemical processes and to better understand the impact of catalyst mass fraction, ϕ. To that end, a series of simulations were performed with varying catalyst mass fraction at a reaction temperature of 400° C. with an initial pressure of 5 bar (absolute) and a 2:1 initial S/C ratio (no other species initially present). The numerical solution was carried out using MATLAB's ode15s differential equation solver.

FIG. 3.5 demonstrates the impact of catalyst mass fraction on CH₄ conversion rates. For a given catalyst/sorbent layer thickness, if the catalyst mass fraction ϕ is 0.75, the conversion initially is relatively fast due to more catalyst sites available to facilitate the reaction. However, as the reaction progresses there is not enough sorbent capacity to effectively remove CO₂ and the conversion reaches an equilibrium value of approximately 72%. Conversely, if there is much more sorbent than catalyst (ϕ=0.10 or 0.05), the reaction is initially much slower but eventually reaches near full conversion. For the geometry and under the ideal conditions considered here, a catalyst mass fraction of approximately 0.25 best balances the need for catalyst to promote the SMR reaction with sufficient CO₂ adsorption capacity.

### Experimental Testbed Demonstration

The final aspect of preliminary work conducted to demonstrate the viability of the proposed research is a bench-scale demonstration of the CHAMP-SORB concept. FIG. 3.6 illustrates the experimental apparatus, including a piston-cylinder fuel accumulator to hold and deliver a CH₄/steam mixture at the appropriate S/C ratio and a quadrupole mass spectrometer (Hiden HPR-20) to analyze the reactor yield. The accumulator, CHAMP-SORB reactor and all lines/valves in between are thermally insulated and heated with electric resistance heaters to maintain sufficient temperatures above the steam saturation point. The membrane and catalyst/sorbent layer are heated to 400° C., controlled by a Harrick 24V automatic temperature controller. The reactor piston is sealed against the cylinder bore using a perfluoroelastomer o-ring with a maximum temperature of 330° C., necessitating the use of cooling water metered through a rotometer at 1 gallon/hr flowing through stainless steel tubing wrapped around the reactor cylinder to preserve the seal. To obtain a fuel mixture at 5 bar absolute total pressure with the appropriate S/C ratio, the accumulator is first heated to 200° C. and filled with CH₄ at 1.66 bar. At this point, the heat tracing on the inlet line (“zone 1”) is turned off such that the temperature is approximately 25° C. Next, a precise amount of H₂O (calculated such that 5 bar total pressure will be reached after vaporization) is injected into the accumulator by the syringe pump. Finally, valve C is closed and power is supplied to the zone 1 heater to vaporize the water.

CO₂ adsorption on the K₂CO₃-promoted hydrotalcite and H₂ permeation across the membrane were first characterized to ensure the component sub-processes occur as anticipated. The hydrotalcite sorbent was promoted with 22% by weight K₂CO₃ using the incipient wetness procedure⁴³ and was crushed and sieved to a diameter range of 0.124-0.297 mm to minimize intra-particle diffusion resistance. For adsorption validation, a 0.25 g layer of sorbent is used in the reactor. A 50 μm thick 77% Pd/23% Ag membrane (Alfa Aesar) was activated by heating to 650° C. for 3 hours⁴⁴ prior to installation in the reactor. The CHAMP-SORB reactor, initially containing Argon at atmospheric pressure, was filled to approximately 5 bar total pressure with either (a) H₂ or (b) CO₂ and the pressure decay was recorded to estimate the permeation or adsorption rate. For both sub-process validation experiments, the results are compared to predictions using the ideal kinetics model developed with initial conditions modified to match that of the specific experiment (i.e., 1 bar Ar/4 bar H₂ for permeation test, 1 bar Ar/4 bar CO₂ for adsorption test).

FIGS. 3.7A and B illustrate a graph the results of the sub-process validation runs and comparison with the kinetics model predictions. FIG. 3.7A illustrates a graph of the reactor is filled with H₂ multiple times with repeatable pressure decay results. The kinetics model matches the experimental results well up until the pressure drops below 2 bar, at which point the experimental permeation rate slows down relative to the modeling results. This is most likely due to large transport resistances for H₂ in the dead volume in the inlet/outlet valves, where it can take longer for H₂ to diffuse to the membrane surface and permeate.

FIG. 3.7B illustrates a graph of the drop in pressure vs. time of the reactor due to CO₂ adsorption. The kinetics model of Lee et al.³³ reports a linear driving force coefficient of 3 min⁻¹ for this particular adsorbent, however, a coefficient of 1.25 min⁻¹ appears to fit the experimental data better. The driving force coefficients are of the same order of magnitude, however, and previous experiments have shown variations in the adsorbent performance based on synthesis method,⁴⁵ so some deviation is expected.

In addition to sub-function validation, the full CHAMP-SORB concept has also been experimentally demonstrated. During the CHAMP-SORB reaction, Argon at a flowrate of 200 sccm was swept across the backside of the membrane (controlled by MFC 3 in FIG. 3.6) to carry the permeated H₂ to the mass spectrometer for analysis. The Ni-based catalyst (HiFuel 110, Alfa Aesar) was crushed and sieved to a diameter range of 0.124-0.297 mm, a value chosen to eliminate intra-particle diffusion resistance based on results reported in Xu et al.²¹ Prior to installation in the CHAMP-SORB reactor, the catalyst was first reduced in packed bed reactor with a continuous flow of pure H₂ at 650° C. for 4 hours, per the supplier's instructions. During the reduction process, the effluent of this reducing reactor was monitored for H₂ O content using the mass spectrometer to confirm that nickel oxide on the surface was properly reduced to active Ni. A catalyst mass of 0.1 g was loaded in the reactor, along with 0.25 g of sorbent.

The following test procedure was followed using the setup illustrated in FIG. 3.6 to generate the experimental data shown FIG. 3.8:
(1) Valves E, G and H were opened and the piston was moved to minimum volume as 15 sccm of Helium flows through the reactor to purge the system.
(2) Accumulator piston was moved by the displacement required to allow final pressure to reach 5 bar.
(3) Valves E and H were closed and valve D was opened to send fuel to the CHAMP-SORB reactor.
(4) The reactor piston was moved to maximum volume and the inlet valve G was closed, isolating the system.
(5) As reaction/adsorption/permeation process occurred, the piston was moved downward to maintain constant pressure using closed loop feedback, and the mass spectrometer measured hydrogen production rate; simultaneously, valve D was closed and valves E & F were opened to purge the feed line with He.
(6) Valve H was slowly opened to send remaining contents inside the reactor to the mass spectrometer.
(7) Valve G was opened to send 15 sccm of purge He to flush out remaining reactor contents.

The corresponding steps from the test procedure are marked on FIG. 3.8 at the time at which they occur. The top plot of FIG. 3.8 shows the ratio of a given gas species detected by the mass spectrometer relative to the Argon signal. During step (5), only H₂ was detected by the mass spectrometer because the reactor outlet valve was closed and only hydrogen can permeate across the membrane. When the outlet valve was opened, the mixture content of the reactor was sent to the mass spectrometer, providing a snapshot of the reactor contents at the end of the experiment. In the experiment shown, the reactor contained predominately CO₂, combined with some unreached CH₄/H₂O and non-permeated H₂.

The pressure and position curves in FIG. 3.8 illustrate a graph of the illustrate one of the experimental limitations of the CHAMP-SORB testbed: presence of a substantial dead volume occupied by the inlet/outlet valves. The closed-loop PID control, implemented using Labview and a Newmark NLS4-series linear actuator, can reliably maintain the pressure at 5 bar for the first half of step (5), at which point the piston reached its minimum displacement. The system volume is non-zero at this point, however, because of the valve volume. From this point onward, the pressure drops in the system as H₂ continues to permeate out of the reactor and no further compression can be applied. The dead volume of the reactor was characterized at room temperature by measuring the change in pressure as a function of piston position; using this data and the ideal gas equation of state, the dead volume is calculated to be 3.97 cm³ out of a total maximum volume of 8.79 cm³. The ideal kinetic model is modified to include this dead volume and used to compare with experimental results for molar H₂ yield rate, reactor pressure, and piston position.

The comparison between simulation and experimental results are summarized in FIGS. 3.9A-C, which illustrate a graph of the experimental H₂ yield rate is determined using mass spec calibration curves obtained prior to the full CHAMP-SORB test. Overall, the model performs remarkably well (considering its minimal use of any empirical parameters) in describing the complex CHAMP-SORB reaction/permeation/adsorption process. The piston does reach its minimum volume position earlier in the experiment than is predicted by the model; however, this is likely due to a slow leak that was observed in the reactor (on average 0.2 bar/min with no reaction or permeation).

The final part of the preliminary experimental work is a demonstration of the impact of CO₂ adsorption on the CHAMP-SORB performance. FIGS. 3.7A and B illustrate a graph of the CHAMP-SORB sub-process experiments for A) H₂ permeation and B) CO₂ adsorption.

FIG. 3.8 illustrates a graph of the CHAMP-SORB experimental results.

FIGS. 3.9A-C illustrate graphs of the comparison of experimental data to ideal kinetic model results for A) H₂ molar yield rate, B) reactor pressure and C) reactor height variation with time.

FIGS. 3.10A and 3.10B show the comparison between (A) a fully functioning sorbent and (B) a sorbent not properly promoted with K₂CO₃ that has essentially zero CO₂ capacity. The insets of these figures show in more detail the relative quantities of the species present at the end of the cycle. Note that FIGS. 3.7A and B illustrate graphs of the CHAMP-SORB sub-process experiments for A) H₂ permeation and B) CO₂ adsorption.

FIG. 3.8 illustrates a graph of the CHAMP-SORB experimental results.

FIG. 3.9A-C illustrate a graph of the comparison of experimental data to ideal kinetic model results for A) H₂ molar yield rate, B) reactor pressure and C) reactor height variation with time.

FIGS. 3.10A and B illustrate a graph of showing essentially no H₂ can be detected by the mass spec as permeated during the reaction process, and at the end of the cycle (around 220 sec), mostly CH₄ and H₂O are present in the exhausted reactor mixture, with the next highest amount of species being actually CO rather than CO₂. In the case of the functioning sorbent, there is minimal CO present in the reactor at the end of the cycle, indicating that the sorbent is effectively promoting the WGS reaction, Eq. (2, Example 2), in the forward direction.

### References for Example 2

1. Rao V. Shale Gas, The Promise and the Peril: RTI Press; 2012.
2. Paltsev S, Jacoby H D, Reilly J M, et al. The future of US natural gas production, use, and trade. Energy Policy. 2011; 39(9):5309-5321.
3. Kargbo D M, Wilhelm R G, Campbell D J. Natural gas plays in the Marcellus shale: Challenges and potential opportunities. Environ Sci Technol. 2010; 44(15):5679-5684.
4. Barreto L, Makihira A, Riahi K. The hydrogen economy in the 21st century: a sustainable development scenario. Int J Hydrogen Energy. March 2003; 28(3):267-284.
5. Lee K B, Beaver M G, Caram H S, Sircar S. Novel thermal-swing sorption-enhanced reaction process concept for hydrogen production by low-temperature steam-methane reforming. Ind Eng Chem Res. 2007 Jul. 1 2007; 46(14):5003-5014.
6. Baade W F, Parekh U N, Raman V S. Hydrogen. Kirk-Othmer Encyclopedia of Chemical Technology: John Wiley & Sons, Inc.; 2000.
7. Rostrup-Nielsen J R. Production of Synthesis Gas. Catal Today. Dec. 31, 1993; 18(4):305-324.
8. Harrison D P. Sorption-enhanced hydrogen production: A review. Ind Eng Chem Res. September 2008; 47(17):6486-6501.
9. Varady M J, Fedorov A G. Fuel reformation and hydrogen generation with direct droplet impingement reactors: model formulation and validation. Ind Eng Chem Res. 2011; 50(16):9502-9513.
10. Ding Y, Alpay E. Adsorption-enhanced steam-methane reforming. Chem Eng Sci. September 2000; 55(18):3929-3940.
11. Hufton J R, Mayorga S, Sircar S. Sorption-enhanced reaction process for hydrogen production. AlChE J. February 1999; 45(2):248-256.
12. Saric M, van Delft Y C, Sumbharaju R, Meyer D F, de Groot A. Steam reforming of methane in a bench-scale membrane reactor at realistic working conditions. Catal Today. Oct. 15, 2012; 193(1):74-80.
13. Marin P, Patino Y, Diez F V, Ordonez S. Modelling of hydrogen perm-selective membrane reactors for catalytic methane steam reforming. Int J Hydrogen Energy. Dec 2012; 37(23):18433-18445.
14. Halabi M H, de Croon M H J M, van der Schaaf J, Cobden P D, Schouten J C. A novel catalyst-sorbent system for an efficient H₂ production with in-situ CO₂ capture. Int J Hydrogen Energy. March 2012; 37(6):4987-4996.
15. Halabi M H, de Croon M H J M, van der Schaaf J, Cobden P D, Schouten J C. Kinetic and structural requirements for a CO₂ adsorbent in sorption enhanced catalytic reforming of methane—Part I: Reaction kinetics and sorbent capacity. Fuel. September 2012; 99.
16. Shu J, Grandjean B P A, Kaliaguine S. Methane steam reforming in asymmetric Pd—Ag and Pd—Ag/porous SS membrane reactors. Appl Catal A-Gen. Nov. 24, 1994; 119(2):305-325.
17. Damm D L, Fedorov A G. Batch reactors for hydrogen production: Theoretical analysis and experimental characterization. Ind Eng Chem Res. Jun. 17, 2009; 48(12):5610-5623.
18. Damm D L, Fedorov A G. Comparative assessment of batch reactors for scalable hydrogen production. Ind Eng Chem Res. Jul. 16, 2008; 47(14):4665-4674.
19. Lattin W C, Utgikar V P. Transition to hydrogen economy in the United States: A 2006 status report. Int J Hydrogen Energy. October 2007; 32(15):3230-3237.
20. Damm D L, Fedorov A G. Conceptual study of distributed CO₂ capture and the sustainable carbon economy. Energy Conyers Manage. June 2008; 49(6):1674-1683.
21. Xu J G, Froment G F. Methane steam reforming, methanation and water-gas shift 1. Intrinsic kinetics. AIChE J. January 1989; 35(1):88-96.
22. Barelli L, Bidini G, Gallorini F, Servili S. Hydrogen production through sorption-enhanced steam methane reforming and membrane technology: A review. Energy. April 2008; 33(4) :554-570.
23. Ritter J A, Ebner A D. State-of-the-art adsorption and membrane separation processes for hydrogen production in the chemical and petrochemical industries. Separ Sci Technol. 2007 Apr. 1 2007; 42(6):1123-1193.
24. Twigg M. Catalyst Handbook Wolfe. New York. 1989.
25. Uemiya S, Sato N, Ando H, Matsuda T, Kikuchi E. Steam reforming of methane in a hydrogen-permeable membrane reactor. Appl Catal. Jan. 3, 1991; 67(2):223-230.
26. Lee K B, Beaver M G, Caram H S, Sircar S. Effect of reaction temperature on the performance of thermal swing sorption-enhanced reaction process for simultaneous production of fuel-cell-grade H₂ and compressed CO₂ from synthesis gas. Ind Eng Chem Res. 2008 Sep. 3 2008; 47(17):6759-6764.
27. Beaver M G, Caram H S, Sircar S. Sorption enhanced reaction process for direct production of fuel-cell grade hydrogen by low temperature catalytic steam-methane reforming. J Power Sources. Apr. 2, 2010; 195(7):1998-2002.
28. Halabi M H, de Croon M H J M, van der Schaaf J, Cobden P D, Schouten J C. High capacity potassium-promoted hydrotalcite for CO₂ capture in H₂ production. Int J Hydrogen Energy. March 2012; 37(5).
29. Harale A, Hwang H T, Liu P K T, Sahimi M, Tsotsis T T. Experimental studies of a hybrid adsorbent-membrane reactor (HAMR) system for hydrogen production. Chem Eng Sci. August 2007; 62(15):4126-4137.
30. Harale A, Hwang H T, Liu P K T, Sahimi M, Tsotsis T T. Design aspects of the cyclic hybrid adsorbent-membrane reactor (HAMR) system for hydrogen production. Chem Eng Sci. Jan. 1, 2010; 65(1):427-435.
31. Ding Y, Alpay E. Equilibria and kinetics of CO₂ adsorption on hydrotalcite adsorbent. Chem Eng Sci. September 2000; 55(17):3461-3474.
32. Ding Y, Alpay E. High Temperature Recovery of CO₂ from Flue Gases Using Hydrotalcite Adsorbent. Process Safety and Environmental Protection. January 2001; 79(1):45-51.
33. Lee K B, Verdooren A, Caram H S, Sircar S. Chemisorption of carbon dioxide on potassium-carbonate-promoted hydrotalcite. J Colloid Interf Sci. April 2007; 308(1):30-39.
34. Hutson N D, Attwood B C. High temperature adsorption of CO₂ on various hydrotalcite-like compounds. Adsorption. December 2008; 14(6):781-789.
35. Anderson D M, Kottke P A, Fedorov A G. Thermodynamic analysis of hydrogen production via sorption-enhanced steam methane reforming in a new class of variable volume batch-membrane reactor. Int J Hydrogen Energy. Oct. 22, 2014; 39(31):17985-17997.
36. Lutz A E, Bradshaw R W, Keller J O, Witmer D E. Thermodynamic analysis of hydrogen production by steam reforming. Int J Hydrogen Energy. February 2003; 28(2):159-167.
37. Rawlings J B, Ekerdt J G. Chemical reactor analysis and design fundamentals: Nob Hill Pub, Llc; 2002.
38. Sircar S, Hufton J R. Why does the Linear Driving Force model for adsorption kinetics work? Adsorption. January 2000; 6(2):137-147.
39. Sieverts A. Palladium and Hydrogen I. Z Phys. Chem. 1914; 88:103-127.
40. Sieverts A. Palladium and hydrogen. II. Zeitschrift fur Physicalische Chemie. 1914; 88(451-78):121-122.
41. Xu J G, Froment G F. METHANE STEAM REFORMING .2. DIFFUSIONAL LIMITATIONS AND REACTOR SIMULATION. AIChE J. January 1989; 35(1):97-103.
42. McLeod L, Degertekin F, Fedorov A. Effect of microstructure on hydrogen permeation through thermally stable, sputtered palladium-silver alloy membranes. Appl. Phys. Led. 2007; 90(26):261905-261905-261903.
43. Walspurger S, Boels L, Cobden P D, Elzinga G D, Haije W G, van den Brink R W. The Crucial Role of the K+-Aluminium Oxide Interaction in K+-Promoted Alumina-and Hydrotalcite-Based Materials for CO₂ Sorption at High Temperatures. ChemSusChem. 2008; 1(7):643-650.
44. Jewett D, Makrides A. Diffusion of hydrogen through palladium and palladium-silver alloys. Trans. Faraday Soc. 1965; 61:932-939.
45. Ebner A D, Reynolds S P, Ritter J A. Understanding the Adsorption and Desorption Behavior of CO₂ on a K-Promoted Hydrotalcite-like Compound (HTIc) through Nonequilibrium Dynamic Isotherms. Ind Eng Chem Res. 2006 Aug. 1, 2006; 45(18):6387-6392.
46. Damm D L, Fedorov A G. Local thermal non-equilibrium effects in porous electrodes of the hydrogen-fueled SOFC. J Power Sources. 2006; 159(2):1153-1157. 47. Hines A, Maddox R. Mass transfer: fundamentals and applications. 1985. New Jersey: PTR Prentice-Hall Incorporated.
48. Deen W M. Analysis of Transport Phenomena (Topics in Chemical Engineering). Vol 3: Oxford University Press, New York; 1998.
49. Bird R B, Stewart W E, Lightfoot E N. Transport phenomena: John Wiley & Sons; 2007.
50. Patankar S. Numerical heat transfer and fluid flow: CRC Press; 1980.
51. Pletcher R H, Tannehill J C, Anderson D. Computational fluid mechanics and heat transfer. CRC Press; 2012.
52. Parks G B, R. Cornish, J. and Remick R. Hydrogen Station Compression, Storage, and Dispensing Technical Status and Costs. In: Laboratory NRE, ed2014.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

We claim:

1. A variable volume reactor, comprising:
a reactor chamber adapted to receive a fuel and a gas in a free volume of the reactor chamber;
a first structure disposed within the reactor chamber, the first structure comprising a catalyst selected to assist a reaction of the fuel and the gas;
an H₂ permeable membrane structure;
an active piston movable within the reactor chamber that changes the free volume of the reactor chamber, the free volume being the space between the active piston and the second structure; and
wherein the variable volume reactor is configured so that products, CO₂ and H₂, are formed due to the reaction of the fuel, wherein the CO₂ is adsorbed by the sorbent material, and the H₂ permeates through the H₂ permeable membrane to outside the variable volume reactor, and wherein the active piston is moveable within the reactor chamber such that:
a first movement of the active piston decreases the free volume and increases H₂ partial pressure in the free volume, which causes an increase of the rate of reaction and hydrogen permeation through H₂ membrane, and
a second movement of the active piston increases the free volume and decreases the partial pressure of CO₂ in the variable volume reactor, which causes the CO₂ to desorb from the sorbent material, and
a third movement of the active piston decreases the free volume to remove the CO₂ out of the variable volume reactor using an open exhaust valve.

2. The variable volume reactor of claim 1, wherein the first structure further comprises a sorbent material, the sorbent material selected to achieve CO₂ adsorption.

3. The variable volume reactor of claim 1, wherein the active piston further comprises a sorbent material, the sorbent material selected to achieve CO₂ adsorption.

4. The variable volume reactor of claim 1, wherein the catalyst comprises MgAl₂O₄, Al₂O₃, and one or more of Ni, Co, Ru, Rh, Pd, or Pt.

5. The variable volume reactor of claim 1, wherein the catalyst comprises a combination of Pt and Al₂O₃, a combination of Rh, Ce, and Al₂O₃, or a combination of Cu, ZnO, and Al₂O₃.

6. The variable volume reactor of claim 8, wherein the catalyst comprises Ni.

7. The variable volume reactor of claim 1, wherein the sorbent material comprises one or more of calcium oxide, lithium zirconate, a hydrotalcite, an activated carbon, a zeolite, an organic-inorganic hybrid, amine-functionalized silica, metal organic frameworks, a branched or hyperbranched polymer, or an ethylene-amine hyperbranched polymer, individually or in combination.

8. The variable volume reactor of claim 7, wherein the sorbent material is a K₂CO₃-promoted hydrotalcite.

9. The variable volume reactor of claim 1, wherein the catalyst comprises Ni and the sorbent material is a K₂CO₃ -promoted hydrotalcite.

10. The variable volume reactor of claim 1, wherein the catalyst and sorbent material are placed in layers and are present in a weight ratio of about 0.1:0.9 to 0.5:0.5.

11. The variable volume reactor of claim 1, wherein the catalyst and sorbent material are admixed and present in a weight ratio of about 0.1:0.9 to 0.5:0.5.

12. The variable volume reactor of claim 1, wherein the H₂ permeable membrane comprises Pd and Ag alloys.

13. A variable volume reactor, comprising:
a reactor chamber adapted to receive a fuel and a gas in a free volume of the reactor chamber;
an active piston movable within the reactor chamber that changes the free volume of the reactor chamber, the free volume being the space between the active piston and the structure, the active piston comprising a sorbent material selected to achieve CO₂ adsorption; and
an H₂ permeable membrane structure;
wherein the variable volume reactor is configured so that products, CO₂ and H₂, are formed due to the reaction of the fuel, wherein the CO₂ is adsorbed by the sorbent material, and the H₂ permeates through the H₂ permeable membrane to outside the variable volume reactor, and wherein the active piston is moveable within the reactor chamber such that:
a first movement of the active piston decreases the free volume and increases H₂ partial pressure in the free volume, which causes an increase of the rate of reaction and hydrogen permeation through H₂ membrane, and
a second movement of the active piston increases the free volume and decreases the partial pressure of CO₂ in the variable volume reactor, which causes the CO₂ to desorb from the sorbent material, and
a third movement of the active piston decreases the free volume to remove the CO₂ out of the variable volume reactor using an open exhaust valve.

14. The variable volume reactor of claim 13, wherein the active piston further comprises a catalyst present, the catalyst selected to assist a reaction of the fuel and the gas.

15. The variable volume reactor of claim 13, wherein the catalyst comprises MgAl₂O₄, Al₂O₃, and one or more of Ni, Co, Ru, Rh, Pd, or Pt.

16. The variable volume reactor of claim 13, wherein the catalyst comprises a combination of Pt and Al₂O₃, a combination of Rh, Ce, and Al₂O₃, or a combination of Cu, ZnO, and Al₂O₃.

17. The variable volume reactor of claim 13, wherein the sorbent material comprises one or more of calcium oxide, lithium zirconate, a hydrotalcite, an activated carbon, a zeolite, an organic-inorganic hybrid, amine-functionalized silica, metal organic frameworks, a branched or hyperbranched polymer, or an ethylene-amine hyperbranched polymer, individually or in combination.

18. The variable volume reactor of claim 17, wherein the sorbent material is a K₂CO₃-promoted hydrotalcite.

19. The variable volume reactor of claim 13, wherein the catalyst comprises Ni and the sorbent material is a K₂CO₃ -promoted hydrotalcite.

20. The variable volume reactor of claim 13, wherein the catalyst and sorbent material are present in a weight ratio of about 0.1:0.9 to 0.5:0.5.
